(19) United States
(12) Patent Application Publication
(10) Pub. No.: US 2024/0128999 A1
(43) Pub. Date: Apr. 18, 2024

(54) WIRELESS COMMUNICATION SCENARIO, DEVICES FOR OPERATING THEREIN, BEACON DEVICE AND METHODS FOR OPERATING THE SAME

(71) Applicant: Fraunhofer-Gesellschaft zur Foerderung der angewandten Forschung e.V., Munich (DE)

(72) Inventors: Thomas HAUSTEIN, Berlin (DE); Paul Simon Holt LEATHER, Berlin-Schlachtensee (DE); Lars THIELE, Berlin (DE)

(21) Appl. No.: 18/394,289

(22) Filed: Dec. 22, 2023

Related U.S. Application Data
(63) Continuation of application No. PCT/EP2022/067420, filed on Jun. 24, 2022.

(30) Foreign Application Priority Data
Jun. 24, 2021 (EP) 21181580.8

(51) Int. Cl. H04B 7/04; H04B 7/06

(52) U.S. Cl. CPC H04B 7/04013; H04B 7/0617

(57) ABSTRACT

A wireless communication scenario comprises a radio propagation environment providing for a propagation of a wireless signal via a path component, the wireless communication scenario comprising a plurality of devices configured for wirelessly communicating in the wireless communication scenario. A member of the wireless communication scenario is configured for identifying the path component of the wireless signal travelling through the radio propagation environment.

### CROSS-REFERENCE TO RELATED APPLICATIONS

This application is a continuation of copending International Application No. PCT/EP2022/067420, filed Jun. 24, 2022, which is incorporated herein by reference in its entirety, and additionally claims priority from European Applications Nos. EP 21181580.8, filed Jun. 24, 2021, which is also incorporated herein by reference in its entirety.

The present invention is related to a wireless communication scenario, to a member of such a wireless communication scenario, to a beacon device, to methods for operating a wireless communication scenario, for establishing an indirect communication between members of a wireless communication scenario and to a computer readable digital storage medium. The present invention is further related to the use of identifiable path components in wireless communication scenarios.

### BACKGROUND OF THE INVENTION

In wireless communication and in particular in wireless communication with high directionality in higher frequency ranges for example, FR2 the involved beamforming can benefit significantly from knowledge about dominant multipath components and under mobility their long-term stability in terms of providing stable connectivity between the transmitter and the receiver.

A simple example may be given by two communication partners A and B, communicating bi-directionally in a Non-Line-of-Sight (NLOS) scenario. FIG. 1a shows a schematic illustration of a multiple input, multiple output, MIMO, scenario FIG. 1b) shows a schematic illustration of a first single input single output, SISO, example #1; and FIG. 1c shows a schematic illustration of a second SISO example. In the examples, buildings 12₁ to 12₄ are locations of base stations, gNBs, 14₁ and 14₂ that communicate with each other via transmission beams 16, 16₁, 16₂ and corresponding reception beams 18, 18₁ and 18₂ along NLOS paths 22, 22₁, 22₂ respectively.

Let's further assume that a set of multi-path components (MPC) are connecting location of A, e.g., of gNB 14₁ with location of B, e.g., of gNB 14₂, some of these MPCs in FIG. 1a are sporadic, e.g., in NLOS path 22₂, due to moving reflectors (cars on a highway) while other MPCs, e.g., of NLOS path 22₁ behave more long-term stable because these are reflections on buildings. Note, that stable reflections may also become sporadically unavailable due to blocking by moving objects for example, vehicles 24 on highway 26.

Reconfigurable Intelligent Surfaces (RISs) are nearly passive surfaces of electromagnetic material that are electronically controlled with integrated electronics and equipped with unique wireless communication capabilities to enhance the classical communication channels within the novel concept of Smart Radio Environments. Such a concept has been recently proposed for a variety of applications, ranging from secure communications, non-orthogonal multiple access, millimetre-wave and terahertz communications, vehicular/aerial communications, and over-the-air-computation to improving the energy efficiency and capacity of wireless networks.

There is, thus, a need to enhance wireless communication.

### SUMMARY

According to an embodiment, a wireless communication scenario including a radio propagation environment providing for a propagation of a wireless signal via a path component may have: a plurality of devices configured for wirelessly communicating in the wireless communication scenario; wherein a member of the wireless communication scenario is configured for identifying the path component of the wireless signal travelling through the radio propagation environment; wherein the member is configured for receiving the wireless signal and an identifier and for deriving, based on the identifier, that the wireless signal was received via the path component for identifying the path component.

Another embodiment may have a device configured to operate in a wireless communication scenario including a radio propagation environment, the device configured for identifying a path component of a wireless signal travelling through the radio propagation environment; wherein the device is configured for receiving the wireless signal and an identifier and for deriving, based on the identifier, that the wireless signal was received via the path component for identifying the path component.

Another embodiment may have a device, e.g., a base station configured for operating in a wireless communication scenario, the device configured for selectively tagging a signal transmitted by the device when directing the signal along a predetermined path in the wireless communication scenario and with a tag that is associated with the path; so that the tag identifies the path.

A recognition of the present invention is that the use of a single path or a multipath communication may be enhanced by identifying the path component allowing a reliable use of the path component, e.g., to distinguish a stable path component from a sporadic or unstable path component which renders the communication more reliable and therefore enhances wireless communication.

According to an embodiment, a wireless communication scenario comprises a radio propagation environment providing for a propagation of a wireless signal via a path component, the wireless communication scenario comprising a plurality of devises configured for wirelessly communicating in the wireless communication scenario. A member of the wireless communication scenario is configured for identifying the path component of the wireless signal travelling through the radio propagation environment. According to an embodiment, a device configured for operating as the member in the wireless communication scenario is provided.

According to an embodiment, a beacon device is configured for operating in a wireless communication scenario. The beacon device comprises a wireless interface and is configured for receiving an incoming wireless signal with the wireless interface and for modifying the incoming wireless signal with a modification to obtain a modified wireless signal. The beacon device is configured for transmitting the modified wireless signal as an outgoing wireless signal with the wireless interface. The modification is associated with the beacon device in the wireless communication scenario to associate a path component of the wireless communication scenario with the beacon device.

According to an embodiment, a method for operating a wireless communication scenario comprises providing a propagation of a signal via a path component of a radio propagation environment, wirelessly communicating in the wireless communication scenario with a plurality of devices such that a member of the wireless communication scenario identifies the path component of a signal travelling through the radio propagation environment.

According to an embodiment, a method for establishing an indirect, e.g., non-line-of-sight, wireless communication between a first member and a second member via an intermediate component comprises controlling the intermediate component so as to comprise different properties, each property influencing relationship between an incoming wireless signal and an outgoing wireless signal, the outgoing wireless signal being obtained responsive to the incoming wireless signal. The method further comprises selecting a property from the different properties such that the incoming wireless signal being transmitted by the first member leads to the outgoing wireless signal being received by the second member or vice versa.

Further embodiments relate to a computer readable digital storage medium having stored thereon a computer program for performing a method according to an embodiment.

### BRIEF DESCRIPTION OF THE DRAWINGS

Embodiments of the present invention will be detailed subsequently referring to the appended drawings, in which:

FIG. 1a shows a schematic illustration of a multiple input, multiple output, MIMO, scenario;

FIG. 1b shows a schematic illustration of a first single input single output, SISO, scenario;

FIG. 1c shows a schematic illustration of a second SISO example;

FIG. 2a shows a schematic block diagram of a wireless communication scenario according to an embodiment showing two devices and communicating via a LOS path which over a distance do;

FIG. 2b shows a schematic block diagram of an example of the present invention for a device of FIG. 2a, for a positioning task;

FIG. 3 shows a schematic representation of a wireless communication scenario according to an embodiment;

FIG. 4 shows a schematic block diagram of a wireless communication scenario according to an embodiment, the scenario having two gNBs operating on different TDD frame structures whereby cross-link interference (CLI) could be created;

FIG. 5 shows a schematic block diagram of a wireless communication scenario according to an embodiment, the scenario having, two stable multipath components, MPCs;

FIG. 6 shows a schematic block diagram of a wireless communication scenario according to an embodiment, the scenario having both stable reflected signals and a non-stable reflected signals travelling;

FIG. 7 shows a schematic block diagram of a wireless communication scenario according to an embodiment, wherein a car shown in FIG. 6 has now moved some distance;

FIG. 8 shows a schematic block diagram of a wireless communication scenario according to an embodiment having a stable MPC from a building a dynamic MPC from a;

FIG. 9 shows a schematic block diagram of a wireless communication scenario according to an embodiment showing a two-way ranging example in an obstructed LOS (OLOS) environment;

FIG. 10 shows a schematic block diagram of a wireless communication scenario according to an embodiment with an example geometrical arrangement of devices;

FIG. 11 shows a schematic timing chart associated with signals being transmitted and received in the scenario of FIG. 10;

FIG. 12 shows a schematic block diagram of a wireless communication scenario according to an embodiment, wherein a different path through the geometrical arrangement of FIG. 10 is illustrated;

FIG. 13 shows a schematic timing chart associated with signals being transmitted and received in the scenario of FIG. 12;

FIG. 14 shows a combination of FIG. 10 and FIG. 12 resulting in a wireless communication scenario according to an embodiment

FIG. 15 shows a schematic timing chart associated with signals being transmitted and received in the scenario of FIG. 14 and in which FIG. 11 and FIG. 13 are combined;

FIG. 16 shows a simplified perspective view of a wireless communication scenario according to an embodiment comprising a reconfigurable intelligent surface, RIS;

FIG. 17 shows a schematic block diagram of a wireless communication scenario according to an embodiment that provides an example of control connections between the gNB, the RIS and the UE;

FIG. 18 shows a schematic perspective view of a wireless communication scenario according to an embodiment that shows two control connections from a set shown in FIG. 17;

FIG. 19 shows a schematic perspective view of a wireless communication scenario that shows different control connections when compared to FIG. 18 and according to an embodiment;

FIG. 20 shows a schematic perspective view of a wireless communication scenario according to an embodiment that shows a use of a single control connection between the gNB and the RIS;

FIG. 21 shows a schematic perspective view of a wireless communication scenario according to an embodiment that shows a use of a single control connection between the UE and the RIS;

FIG. 22 shows an identifiable beacon associated or embedded with the UE according to an embodiment;

FIG. 23 shows an identifiable beacon associated or embedded with the ng-gNB according to an embodiment;

FIG. 24 shows an identifiable beacon associated or embedded with the gNB according to an embodiment;

FIG. 25 shows an schematic block diagram of a wireless communication scenario according to an embodiment; having an arrangement of functional entities used for communication and/or positioning purposes including a RIS and an identifiable beacon;

FIG. 26 shows an schematic block diagram of a wireless communication scenario according to an embodiment wherein the RIS of is connected to the UE via control connection;

FIG. 27 shows an schematic block diagram of a wireless communication scenario according to an embodiment wherein RIS is connected to the gNB-DU via a control connection;

FIG. 28 shows an schematic block diagram of a wireless communication scenario according to an embodiment wherein the RIS is connected to the LMF via a control connection;

FIG. 29 shows an schematic block diagram of a wireless communication scenario according to an embodiment wherein the RIS is connected to the AMF via a control connection;

FIG. 30 shows a schematic block diagram of a method according to an embodiment that may be used for operating wireless communication scenario;

FIG. 31 shows a schematic flow chart of a method according to an embodiment that may be used for establishing an indirect, e.g., non-line-of-sight wireless communication between a first member and a second member via an intermediate component; and

FIG. 32 shows a schematic block diagram of a beacon according to an embodiment, that may be used, for example, as beacon described herein.

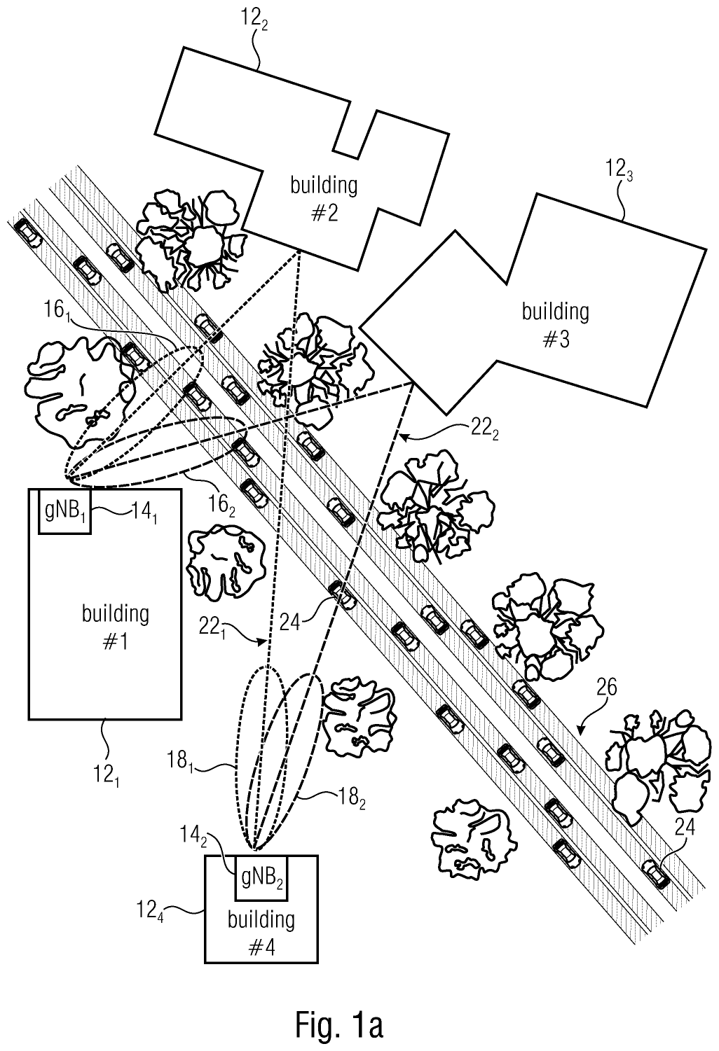

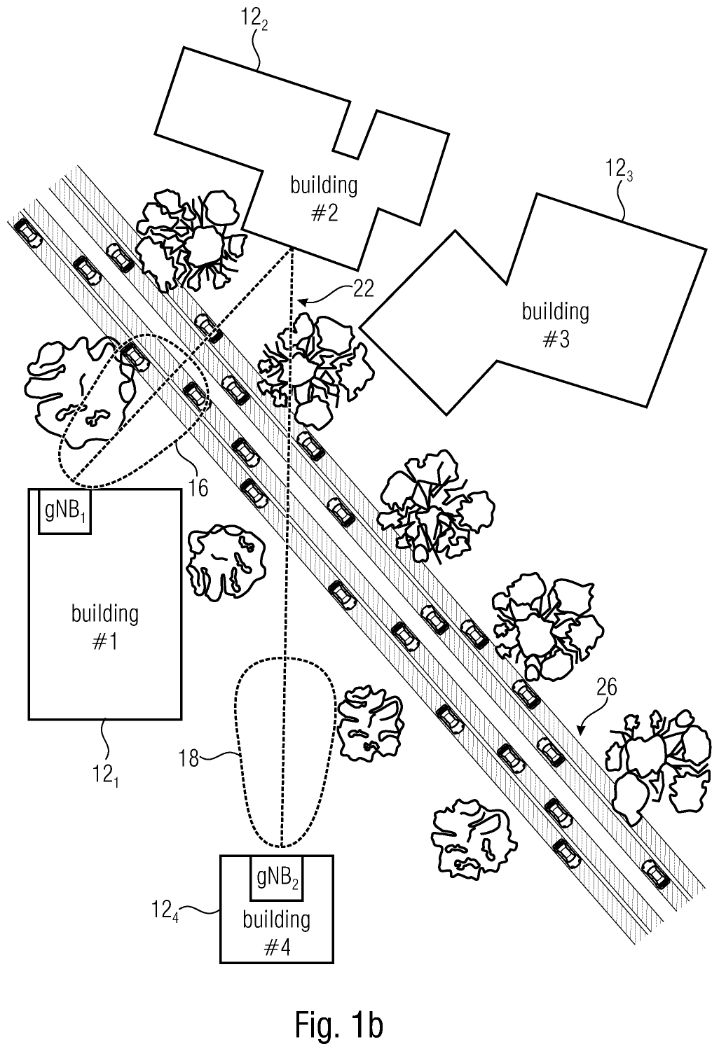

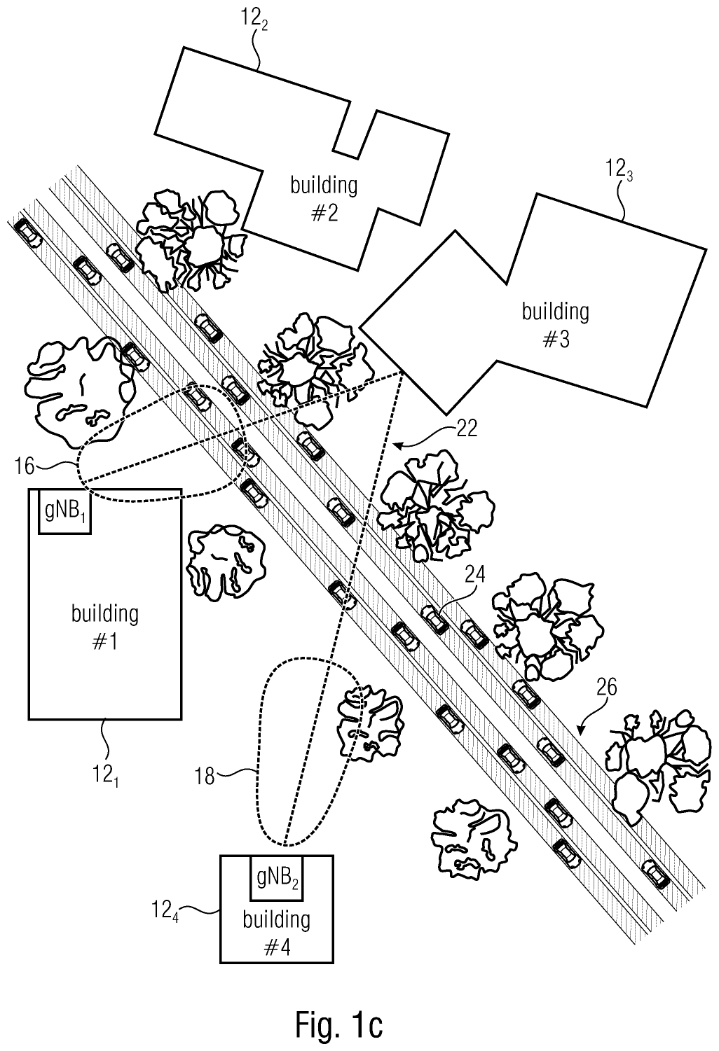

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

A wireless communication scenario described herein may relate to a set of devices communicating with one another in a unidirectional or bidirectional manner, possibly but not necessarily in a wireless communication network. However, wireless communication scenario may also comprise entities, items, objects or functionality outside the network that form nevertheless a part of a network, e.g., a reflecting structure, a relay or reconfigurable surface and/or repeater, not controlled by the network.

A member of the wireless communication scenario may be any object and/or device participating in the propagation of a wireless signal, e.g., by transmitting, receiving, reflecting and/or scattering a signal. A member that identifies a path component as provided as an embodiment, may be an active device, e.g., a transmitter and/or receiver such as a UE, an IoT device, a relay/repeater, a reconfigurable intelligent surface, RIS, a base station or gNB or the like.

Embodiments described herein relate to a beacon. Such a beacon may be or may comprise any information in the wireless communication scenario that is associated by at last one member with the presence, existence or availability of a path component. For example, a beacon described herein may comprise, may be or may be associated with a passive or active element or structure in the wireless communication scenario. Such a beacon may be or may comprise an active element that includes a piece of information into an inband or out-of-band signal recognised by a different apparatus. The beacon may alternatively or in addition comprise information about a presence of at least one object in a proximity of a device, a relative orientation of a device with regard to the at least one object, a visibility or the like of a subset of objects from a set of known objects or the like.

A Beacon may also relate to a plurality of objects that form a group of objects, i.e., they are recognised, in the wireless communication scenario as a group. Such a group may, for example, appear differently from different directions and may thus provide for a different way of beaconing or tagging from different directions.

Entities described in connection with the present embodiments may refer to participants of a wireless communication. Such entities may comprise one or more wireless interfaces, not precluding additional wired interfaces. Further, such entities my comprise processing units configured for evaluating received signals and/or to generate signals to be transmitted. Examples of such entities are user equipment, IoT devise, base stations or other mobile or stationary devise participating in the communication.

Embodiments of the present invention related to identifying path components in a wireless communication scenario. As a wireless communication scenario one can understand a scenario providing for a wireless propagation environment. Such a scenario is not necessarily limited to a single wireless communication network that can comprise at least two devices operating in a network, two devices communicating without a network or a set of networks or combinations thereof. The provided communication may be influenced by the environment which is mapped in the radio propagation environment that enables propagation of a signal along one or multiple paths from one member to another.

Embodiments relate to a wireless communication system or scenario using beamforming therefore that is enabled to make “educated” beamforming decisions with respect to stability of available MPCs in a given scenario/link geometry which results in the following problem statement:

Problem Statement #1 (communication centric): a device using MIMO/beamforming for connecting with another node may select instable MPCs if not provided with additional side information allowing to identify/categorize MPCs with respect to the long-term or short-term stability and associated communication path contribution.

The resulting task solved with embodiments described herein is to provide the communication system with means allowing to categorize/identify specific MPCs as being associated with long-term stable reflections, thus choosing long-term stable MPCs vs. simple power-based path and beam selection.

This allows the bi-directional communication to be optimized according to resilient selection of MPCs in a given propagation environment.

Another common task to be solved by means of wirelessly transmitted signals is absolute or relative positioning for localization of a device or navigation along a path.

In known wireless systems various means for positioning/localization are provided, all based on known positioning reference signals, RS, and known positions of the transmitters or receivers. Based on these RS and the provided side knowledge the position of a wireless transmitter and/or receiver can be determined.

In strong multi-path environments and/or under use of beamforming signal ambiguities may occur increasing the measurement uncertainty (MU) significantly and within varying bounds. Furthermore, absolute positioning usually needs at least 4 anchor points sufficiently well distributed in space. In many scenarios this is hard to achieve/realized for example, outdoor to indoor scenarios, therefore an increase and a reasonable distribution of localization anchor points in space will benefit the accuracy and reliability of existing positioning methods.

Problem Statement #2 (localization centric): a device or networks nodes around the device performing a positioning task of the device using wireless reference signals (RS) in uplink (reverse link) and/or downlink (forward link) where certain transmitter/receiver locations are known will suffer in terms of positioning performance for example, due to reduced solvability of the problem (underdetermination of a set of equations) or insufficient number and/or distribution of known positioning anchor points in space.

The resulting task solved with embodiments described herein is to provide a sufficient number of known positioning reference points without further increasing the number of active transmitting or receiving communication node in a wireless system, advantageously these reference points are passive, frequency agnostic and of low cost and easy to deploy and need no maintenance and certification.

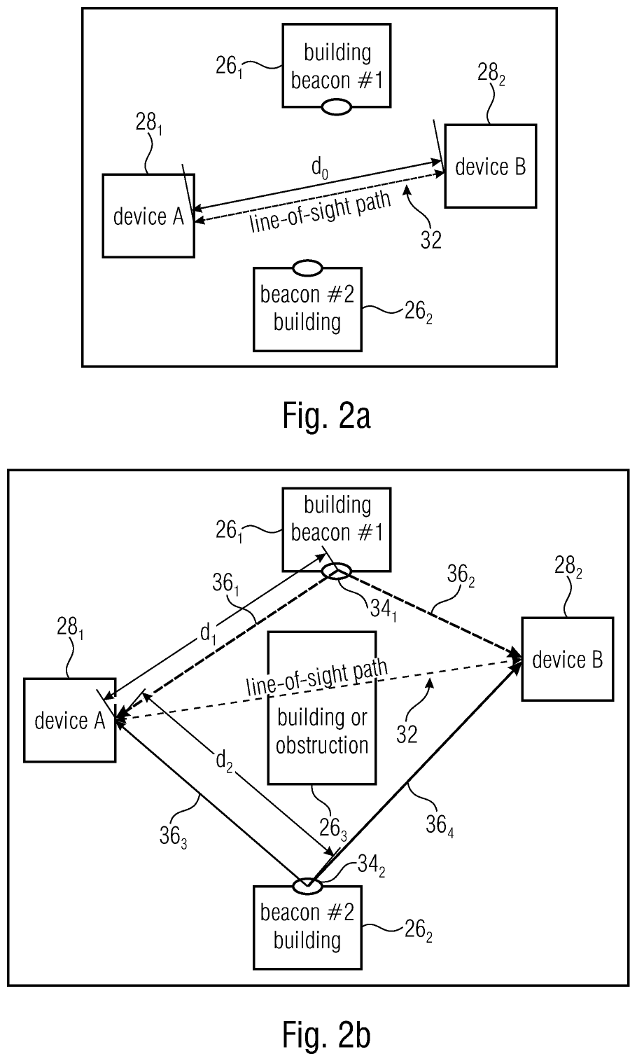

In FIG. 2a, a line-of-sight (LOS) scenario is shown in which devices 28₁ (A) and 28₂ (B) can use a line-of-sight-path 32 to perform a two-way ranging to determine the distance do between them. For example, the line-of-sight scenario allows ranging to only determine the distance between two devices, even if the location of one device is already known. However, without any further location anchor (or reference point) it is not possible to determine their absolute position. Moreover, even when the location of a first device is known, ranging does not provide sufficient information to allow the location of the second device to be determined other than that it is located on a sphere with the radius of the estimated range around the known point. The figure also shows the location of two beacons attached to two buildings.

FIG. 2b shows an example of an obstructed LOS (OLOS) scenario. Here, although there is no LOS path available between device 28₁ (A) and 28₂ (B), there are two distinct path components or multipath components (MPCs) 36₁ and 36₂ on the one hand and 36₃ and 36₄ involving reflections from objects fitted with a beaconing device 34, 34₂ respectively. The OLOS scenario also represents an example of a blocked-LOS (BLOS) or non-LOS scenario. The terms OLOS, BLOS and non-LOS are thus interchangeable. Since the location of the two beaconing devices 34₁ and 34₂ is known in the given example, the combination of one-way ranging towards beacon 34₁ and 34₂, e.g., to determine distances d₁ and d₂ for device 28₁ and an absolute timing reference point allows the location of devices to be estimated. A beacon 34 may be or may comprise a beaconing device, i.e., an apparatus providing for a source if identification which is associated with the path component it provides so as to allow to identify the path component. Such an apparatus may be an active, powered structure but may also be a passive element such as a recognised structure, (optical) pattern or any other item detectable by an apparatus.

FIG. 2a shows a schematic block diagram of a wireless communication scenario showing two devices 28₁ and 28₂ communicating via a LOS path which over a distance do. Buildings 26₁ and 26₂ may optionally participate, according to an embodiment, by use of beacons explained in connection with FIG. 2b that allow to identify path components contributing to such reflection. Optionally, device 26₁ and/or 26₂ may comprise a beacon, e.g., to identify the device and/or the LOS path component thereof, i.e., the LOS path component.

FIG. 2b illustrates an example of this for device 28₁ (A) which determines the point of intersection of the two radii d₁ and d₂ and, together with knowledge of the absolute locations of beacon 34₁ and 34₂, estimates the location of device A. Such a procedure benefits from reliably knowing or identifying the path components 36₁ to 36₄.

Both problems are addressed and solved by the embodiments described herein.

Embodiments provide for a solution for the questions “How can communication (problem statement #1) and localization (problem statement #2) benefit from the knowledge that a signal has travelled over a path (component) or multi-path component (MPC) which can be clearly associated with a beacon?”

Furthermore, this invention disclosure is not providing limitations on how a beacon can be produced even though the embodiments may differentiate between beacons specifically created or introduced at the location of the wireless path—the point at which one or more of reflection, diffraction and scattering (passive or active) occurs—and beaconing introduced by the original source (gNB/BS) by providing beaconing for example, on a particular beam (SSB, CSI-RS beam) which may be obtained by tagging a path component by tagging the transmitted signal.

Embodiments are based on the finding that for a communication both devices at the end of a link may see or recognize the same object/component when correlating to a path component or multipath component and conclude that this object reflects the signal and forms part of the path. Some embodiments may use a beacon for such identification. However, the identification of a path component may also be performed without such an entity, e.g., when evaluating, if a path component arrives from a specific direction (e.g., left and right) and by associating such information with other data, e.g., a recognized identifier or a shape of a building being detected with a camera, e.g., an internal camera of a UE or the like. An associated MPC information may comprise, for example, information indicating that a member, e.g., a gNB, can see a building with a particular beam (SSB), but this does, e.g., not mean that an effective MPC to a device (receiver) can be established/use/detected (e.g. wrong angle).

A path or multipath component may provide a connection between two points. However, an intermediate reflector/scatterer or signal emitter may be a part of many MPCs between many pairs of devices/members. That is, a set of identifiers of a beacon and associated properties of the reflector/scatterer/attenuator may be used in several connections.

Embodiments are based on the finding that a multipath component detected by a device may not only serve as a basis for communication but may also be associated with additional information. Such additional information that allows to identify the path component may include any additional knowledge and additional information that is correlated with the path component. For example, this may relate to a specific pattern detected in the path component, the specific pattern caused, for example, by a scattering or reflection of an object such as a building. Alternatively or in addition, the device may recognize a time of availability of the path component so as to determine whether the path component is reliable as being available over a time being at least a time threshold or being sporadic, e.g., as being provided by a car that is moving. This does not preclude to determine patterns in time related to an availability or unavailability of the path component and to associate such information with the path component. That is, the present invention extends the recognition of a presence of a path component by associating further information with the path component.

Some embodiments relate to a device or object that forms part of the propagation environment. For example, this may be a scattering object scattering an arriving or incoming signal. Alternatively or in addition, the object may be reflective, at least partly transparent, may change a polarisation of signals and/or may provide for other effects as described herein. This may result in a signal departing from the device or object which referred to herein as outgoing signal. The outgoing signal is based or caused by the incoming signal, which is also valid for a device that receives the coming signal and forwards it as the outgoing signal/and/or performs signal processing, e.g., similarly to a decode and forwards process. That is, the incoming signal may be subject to an active and/or passive operation and the outgoing signal may be generated or obtained in different ways but is casually related with the incoming signal.

A beacon that provides for an identifier that allows to identify the path component may operate without synchronisation with the wireless scenario, e.g., when providing an out-of-band signal, but may also operate synchronic, e.g., when actively generating a signal within the wireless communication network.

According to an embodiment, the beacon, e.g., as a device actively communicating, may be configured for providing information, e.g. via an exposer/exposure function, about a database associated with information about the beacon in, e.g., a beacon register of the wireless communication scenario. Alternatively or in addition, such information may be provided by any different device in the wireless communication scenario having knowledge about the beacon, e.g., upon reception of such information and/or recognising the beacon. Such a report may also relate to non-communicating beacons, regardless whether they are active devices or passive items, information, parameters or the like, i.e., a device may report a basis of information reporting to others that it associates a specific path component with a beacon and/or may report such a beacon.

According to an embodiment, the member and/or the beacon and/or a different device of the wireless communication scenario is configured for reporting the information associated with the beacon to the wireless communication scenario.

According to an embodiment, the beacon is configured for requesting or receiving the information associated with the beacon, or reported by beacon to the wireless communication scenario.

### Beacon Signal Attributes

Attributes describing the beacon signal properties are: periodicity, directionality, polarization, sequences, patterns, temporal availability and/or validity, frequency range, signal strength, code, signatures, reference signals, radar cross-section (E.g., an around the corner radar like reflector can be in form of a cylinder, a prismatic surface etc. that allows for a Direction-tuneable specular reflector or the like)→this to be included in the analysis at the observer/receiver and conclusion/decision making process. That is, such attributes or properties may identify a beacon, i.e., a multipath component associated with it.

Beacon type: active, passive, just—marker, containing a message beyond the identity. While active beacons can be turned ON and OFF, a passive beacon is always ON.

A beacon signal may be a signal that may contain or may interpreted, at least parts thereof, as an identifier. Such an identifier may be recognised as being a part of the communication scenario but also be something different, e.g., an agreed interpretation of a shape of an item, a signal in a different frequency range or the like.

The beacon may be configured for providing the identifier as at least a part of at least one of:
an optical signal;
an acoustic signal;
a visible or non-visible signal with respect to a human eye;
an inband signal;
an out-of-band signal transmitted by the beacon and being out-of-band with regard to the incoming signal;
an out-of-frame signal being out-of-frame with regard to a frame of an outgoing signal being based on the incoming signal;
out-of-slot signal being out-of-slot with regard to a slot of an outgoing signal being based on the incoming signal;
out-of-channel signal being out-of-channel with regard to a channel of an outgoing signal being based on the incoming signal;
out-of-bandwidthpart, BWP signal being out-of-BWP with regard to a BWP of an outgoing signal being based on the incoming signal;
as a signal in an uplink slot, e.g., as a base station;
a pattern or structure of the beacon;
a shape of the object or of the beacon;
a modification applied to the incoming wireless signal by the object, e.g., as a passive beacon that may change, e.g., a polarization
an information included by the beacon into the incoming wireless signal.

According to an embodiment there is provided the wireless communication scenario, wherein the device is configured for including an information included by the beacon into the incoming wireless signal to implement the modification; wherein the information is associated with the beacon and comprises at least one of:
an identifier of the beacon;
an identifier per beam direction of the beacon;
a location of the beacon; or
an operation mode of the beacon.
A frame structure of the beacon
A sync structure of the beacon e.g. PSS; SSS

For example, a beacon according to an embodiment may be configured for implementing the modification so as to include a tag into the outgoing signal.

According to an embodiment there is provided the wireless communication scenario, wherein the identifier of the beacon is updated according to a condition or requirement.

Referring again to the terms incoming and outgoing, as an incoming signal a signal can be regards that is transmitted by a first device (transmitter) (or being an outgoing signal of a different member/component) and that may be intended to be received by a second device (receiver) via at least one of the multipath components, MPCs.

A beaconing device may be located along the path of a MPC, e.g. located within a scattering region or at a reflective surface or near antennas, and may modify or enrich the forwarded signals along the particular MPC between the transmitting device and the receiving device.

Along the path (one particular MPC) the signal may be modified by adding, subtracting, modulating the original signal in parts or in total (inband) or adding an additional signal e.g. a blinking light as an outband beacon/identifier.

According to embodiments, the beacon doesn't necessarily know anything about a transmitter and or a receiver. Therefore, it is not necessarily aware of an incoming signal. The beacon device may be placed at a strategic position the provide references/identifiers if this strategic position becomes part of a dominant MPC and therefore becomes an identifiable MPC.

### Detected a Beacon Signal

A beacon signal can be detected by a receiver equipped to receive beacon signals. This may include, for example, a sensor unit to detect the beacon and a determination unit possibly comprising a processor, a microcontroller, an application specific integrated circuit or the like, to evaluate a sensor signal received from the sensor unit. For example, the sensor unit may comprise a camera and the determination unit may evaluate the camera signal for a pattern that is associated with the beacon. Alternatively or in addition, the sensor unit may comprise the antenna unit or antenna array of the receiver device and the determination unit may be coupled to a signal processing unit or may be part thereof to evaluate the frame structure or sync structure.

### Controlling a Beacon Signal

A device able to produce a beacon, i.e., a beacon device, can be configured before, during or after its installation or deployment with at least one of the following functionalities:
configurable via a communication link—for example, NBIoT
activable (wirelessly, optically, acoustically, electrically)—that is, woken up
responsive to a dedicated sequence—for example, a trigger
capable of executing a beaconing procedure or sequence or a beaconing signalisation

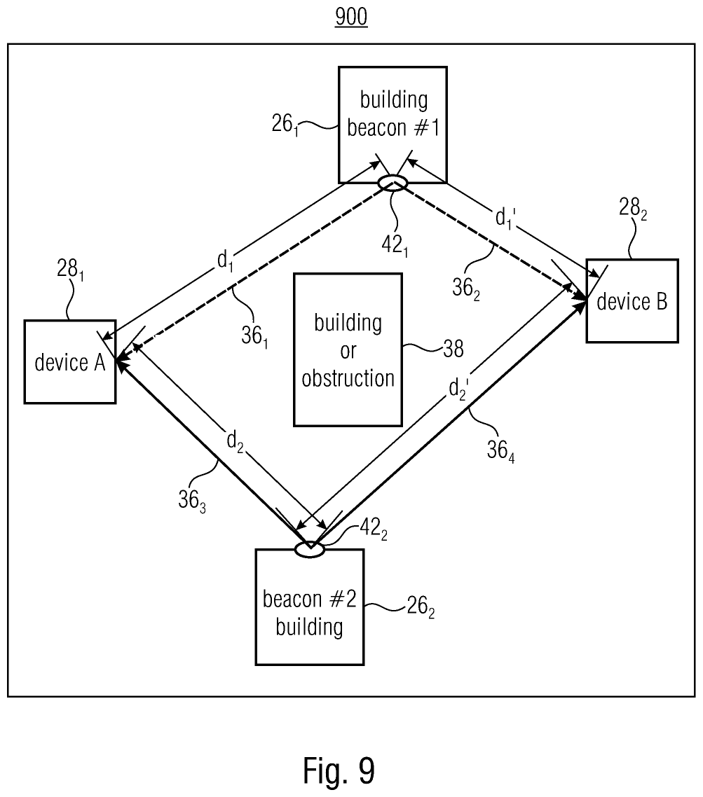

As an example being illustrated in FIG. 9 modifying FIG. 2b and showing buildings 26₁ and 26₂ that provide for NLOS paths between devices or members 28₁ and 28₂ as an obstruction, e.g., a building or a different object at least partially blocks the LOS path, a base station or another controlling entity of the wireless communication scenario may be configured for activate beacons 42₁ and/42₂ in order to identify 1st order reflection paths (MPCs) between a transmitting/receiving UE 28₁ and a receiving/transmitting base station, e.g., device or member 28₂. With further knowledge of the location of the beacon-identifiable MPCs one- or two-way ranging over NLOS MPCs is possible to determine distances d₁, d₁′, d₂ and/or d₂′. The beacons 42₁ and/or 42₂ may perform at least some functionalities as beacons 34₁ and/or 34₂ bur may be controllable in view of the operation mode, their activity, e.g., ON/OFF, their orientation or the like. That is, whilst a beacon 34 does not exclude such functionality, a beacon 34 may be implemented as an identifiable component of the radio propagation environment, e.g., as a passive structure having identifiable properties or identifiable influence in the radio propagation environment, a beacon 42 may be controllable in view of its behaviour which may result in an active, controllable component of the beacon itself or a structure coupled thereto, e.g., an actuator for moving the beacon to change its influence. An active beacon may change its signal processing, it reflection characteristic or the like.

A beaconing device in accordance with an embodiment can be further equipped with a power supply and/or can use energy harvesting (radio frequency, RF, solar, nuclear, etc), e.g., by comprising or being connected to an energy harvesting module.

### Beacon Signal Information

The beacon signal, e.g., as an outgoing wireless signal, may provide information that can be used to determine where it came from for example, the location of the beacon and the identity of the beacon itself (for example, ID #4). Such information may be at least in parts explicitly contained as an information element in the beacon signal but may alternatively or in addition at least partly contained as implicit information, e.g., as a direction, polarisation, frequency range, used format, timing or the like experienced or detected at the receiving member.

### Exploiting a Beacon's Location

For example, according to an embodiment, a member of a wireless communication scenario may be configured for using an origin of the beacon signal to determine properties and characteristics of the propagation channel, for example, to identify MPC, sources of interference, the location of other devices and/or network elements, the position of known hazards.

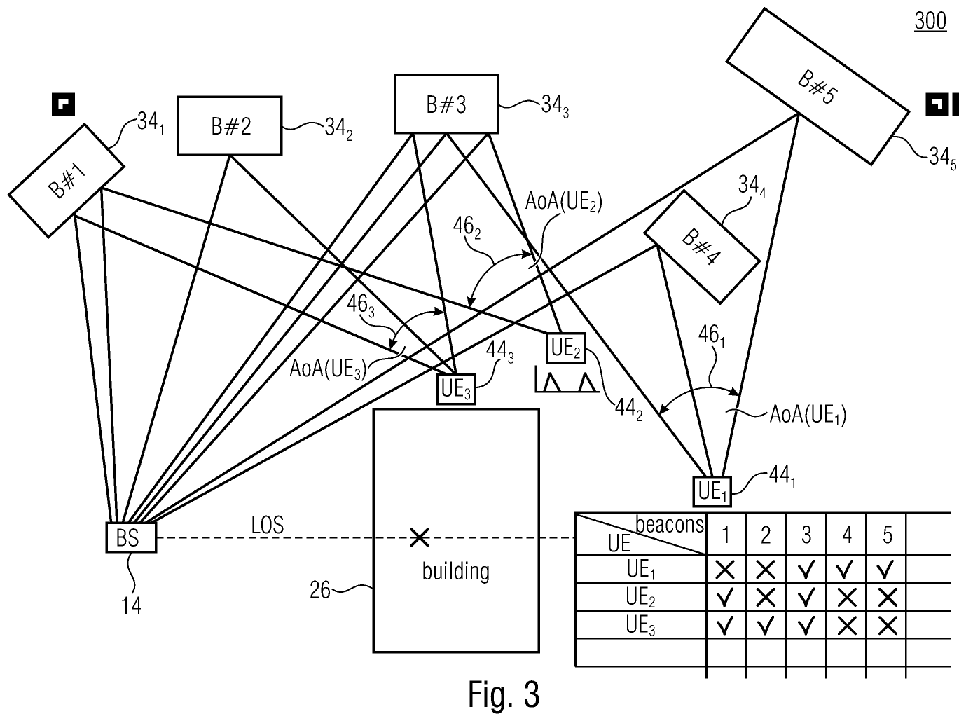

FIG. 3 shows a schematic representation of a wireless communication scenario 300 according to an embodiment, and a connectivity graph of several UEs 44 connected with the base station 14 in an OLOS scenario using strong MPCs as reflection points, indicated by beacons 34₁ to 34₅. The received angle of arrival (AoA) spectrum of signals at the respective UE provided by the propagation channel is depicted by an arch 46₁ to 46₃ spanning the widest range of relevant MPCs for a particular UE 44₁ to 44₃. The first order reflectors/scatterers are marked by beacons 34₁ to 34₅ having number #1 . . . #5 advantageously allowing to associate MPCs with reflection at certain locations and/or directions.

In the scenario of FIG. 3 where a BS 14 and UEs 44₁ to 44₃ are connected over MPCs which span a significant angle range seen from the perspective of the antenna array at the BS 14 and/or the UE. By marking the MPCs with beacons the burden of precise directional resolution of the AoA spectrum can be relaxed by providing data about the locations of the objects providing or carrying a beacon 34₁ to 34₅.

Such mechanism allows to correlate directions or spatial segments covered by a particular beam widths/field of view (FOV) without elaborate spatial scans and or advanced array signal processing. Since the beacon signals are to be received by the receiver as a function of the receiver's radiation pattern, the receiver is able to evaluate levels of the distributed received beacons and overall received signal strength from the communication partner (transmitter). This can be observed for different receiver radiation patterns/receive beam configuration with and without beam sweeping. As a result, a member or device may be able to correlate the receive beacon signals with the observed RS signal from the communication partner. Further signal processing and analysis may provide additional insights into the path-resolved signal distribution, stationarity and stability of paths/taps and their associated phase evolutions. Applying suitable metrics different MPCs can be identified to coincide with particular beacon signals and their properties with respect to suitability as dominant MPCs for further use in the beam management (alignment/tracking/radiation pattern selection etc.).

Alternatively or in addition, based on additional information if the beacon is adding an active signal or modifying the reflected signal in an identifiable manner, according to an embodiment, the receiver may further distinguish between signal changes resulting from e.g. movements of the transmitter, a particular reflection source of a MPC or the receiver. Such MPC identification procedure can be performed at each end/side of an unidirectional communication link, e.g., by receiving information from the beacon at the receiver and/or the transmitter, the information possibly but not necessarily contained in a wireless RF signal, e.g., when taking a camera picture from a beacon. Such MPC identification procedure can also be performed at each end/side of the bidirectional communication link resulting in different views/perspectives about the distribution of beacons and dominant MPCs in angular range/spherical directions. Knowledge about the angular distribution and/or mapping of MPCs for the communication link and/or interference can be exploited at the receiver side for reception and transmission and or shared/exchanged in order to allow the communication partner to exploit such information.

The information (e.g., Channel State Information, CSI) may be provided with respect to angles, directions, beacons etc.

Based on the capabilities of the transmit/receive arrays of the communication partners the transmit and/or receive beam/radiation patterns can be chosen according to various criteria/metrics, e.g. minimization of interference (ICI and/or CLI), optimizing SNR, SINR, maximising the received signal strength, selectively choose/avoid particular stable/unstable MPCs in mutual beam management procedures and/or track certain unused MPCs as backup MPCs in case of blockage or other link degrading events.

### Exploiting a Beacon's Identity

According to an embodiment, beyond or as an alternative to the location of the beacon, its identity may provide information that can be further used to determine information about the object to which the beacon has been fitted or mounted (for example, a fixed structure: building, tower, roadside furniture; a relocatable/transportable structure: a fence, a barrier; a mobile structure: a vehicle, a pedestrian a cyclist)

Such information may be stored in a database accessible for the member to make use of identification of a beacon, may be transmitted via a signal to the member and/or may be stored locally in a data storage of the member.

### Using Additional Beacon Information

According to an embodiment, a beacon identity may be associated with properties such as a change of polarization, reflection coefficient or the distribution or probability of blockage. The latter is defined here as a function of the location and position of the transmitter and receiver and the environment—the distribution of objects, either stationary or otherwise—in which they reside. Examples of which are not limited to include the following:
A flat and extended building façade/surface
A well-defined MPC/scattering region for example, a small patch of forest or bushes
A polarization changing surface, for example, glass, water (other dielectric) of significant extension

Such information may be stored in a database accessible for the member to make use of identification of a beacon, may be transmitted via a signal to the member and/or may be stored locally in a data storage of the member.

### Using Beacon Oath Knowledge

Embodiments may also use knowledge that a signal has propagated over a path comprised of one or more beacons can be used in applications for both communications and localization purposes. Examples of such applications are described separately in the following sub-sections.

### For Communication Purposes:

According to an embodiment, a receiver member can discriminate incoming (received) signals into multi-path components (MPC) which are dominant/significant for a desired signal/communication of a device with its serving base station or communication partner. The member of the wireless communication scenario may select or combine a subset of these MPCs in an educated fashion about MPC stability, longer term availability (visibility), blockage probabilities, accessibility with beamforming capabilities etc. That is, the member may select one or more MPC to be used for communication based on one or more criteria. This may include keeping track of alternative MPCs available for fast link failure recovery and link degradation counter measures without full search for alternative MPCs once or after link degradation and or failure happened. This knowledge can be used to adapt/improve/optimize performance for both reception and transmission purposes. That is, according to an embodiment, the member may be configured for identifying a plurality of path components, e.g., the available or suitable path components available for the member for being used for the wireless communication and for selecting a subset from the plurality of path components for the wireless communication based on a criterion which may comprise to not select at least one available path component from the plurality of path components. The member may use the selected subset for the wireless communication. In advance of the need to have the selection being made, e.g., by tracking or selecting during selection of the first subset, the member may be configured for selecting an alternative or auxiliary second subset of path components, e.g., prior to or during using the first subset. The member may use the second subset instead of the first subset in case of a link degradation or link failure, i.e., it may switch from the first subset to the second subset in case of a predetermined event or signal.

For example, a member such as a UE or a gNB may be configure a UE to have 2 subsets available and to switch between them or select between them based on a condition and/or based on a direct control.

According to an embodiment, the member is configured for identifying a plurality of path components available for the member for wireless communication and for selecting a subset from the plurality of path components for the wireless communication based on a criterion whilst not selecting at least one available path component from the plurality of path components and for using the selected subset for the wireless communication.

According to an embodiment, the member is configured for identifying a plurality of path components available for the member for wireless communication and for selecting a subset from the plurality of path components for the wireless communication based on a criterion whilst not selecting at least one available path component from the plurality of path components and for reporting the selected subset to another member of the wireless communication scenario as:
advantageous or not advantageous for the wireless communication; or
being used in the wireless communication with another member.

According to an embodiment, the member is configured for selecting the subset as a first subset and for selecting a second subset of path components prior to or during using the first subset; and for switching from the first subset to the second subset based on a predetermined event or signal.

According to an embodiment, the member is configured for using a first subset prior to using a second subset of path components; and for switching from the first subset to the second subset based on a predetermined event or signal; or
selecting to use of the first subset or the second subset based on predefined criteria or event.

A receiver can discriminate incoming (received) signals into multi-path components which are joint/dis-joint for a desired signal/communication of a device with its serving base station or communication partner and or an interference signal arriving over the same MPC from an interfering source. As a result, the receiver in accordance with an embodiment, may discriminate/avoid reception from interfered MPCs by beamforming and/or the transmitter (gNB/BS) could change transmission strategy over such MPCs which are prone to interference by for example, adjusting transmission delay precoding, beamforming, redundancy etc. In the reverse direction/uplink the device can make use of this information in order to avoid/reduce potential interference to other devices (UEs, base stations etc.).

The TDD and FDD examples given herein can be applied to Full Duplex Communication scenarios in order to reduce/mitigate/avoid cross link interference (CLI) and inter cell interference (ICI).

### For Localisation Purposes:

A receiver can discriminate certain MPC marked with a distinguished beacon signals as virtual and/or distributed positioning beacons. Provided with further knowledge about the distance or path-delay between the base station (gNB) and the location of the beacon, the device can determine a set of distributed positioning anchors which can be used for TOF or direction-based positioning schemes.

### Beacon Information Accessibility, Availability and Control

The following list provides embodiments of message formats, message content, message exchange orders and procedures to enable devices to gain knowledge about the existence of beacons and their associated attributes:
Configure a device/receiver to extract/observe/measure particular features aka “beacon (reference) signals”, for example, an almanac of beacons available in certain areas, bands, RAT, provided by . . . etc. Such information may be in-band, e.g., explicitly or implicitly contained in a wireless signal transmitted by the beacon or may be out-of-band, e.g., by knowing a shape, position, behaviour or the beacon.
Device/receivers can share capability information for beacon detection and/or request associated side knowledge from the network.
A base station/gNB/a network or any other entity (for example, a data base) may provide capability indication/information that may support wireless propagation exploration or localization through the use of beacons.
Authentication procedures for access to beacon signal and beacon identity related information. Maybe on subscription base, group base (belonging to a service class for example, first responders, Public Protection and Disaster Relief (PPDR), etc.). Access can be provided on different levels, providing different benefits, accuracy for the final application to be operated for example, localization with different measurement uncertainty (MU) like in GPS (civilian and military accuracy). For example, access to the database may be based on an authentication procedure to authenticate the member. Optionally, a level of authority of the member may determine a level of access granted to the member.

According to an embodiment, the member is a first member, the wireless communication scenario comprising a second member; wherein the first member is configured for determining a position of the first member based on a beacon and based on the path component associated with the beacon; and/or wherein the first member is configured for determining a position of the second member based on a beacon and based on the path component associated with the beacon.

According to an embodiment, the first member is configured for determining a position of the first member based on at least one of: a known position of the beacon and based on the path component associated with the beacon; and/or an amplitude, a delay and/or a phase associated with the beacon; a known position of the second member, e.g. a gNB, based on the path component associated with the second member; and an amplitude, a delay and/or a phase associated with a signal originating from the second member.

According to an embodiment, the first member is configured for determining a position of the second member based on at least one of: a known position of the beacon and based on the path component associated with the beacon; and/or an amplitude, a delay and/or a phase associated with the beacon; a known position of the first member based on the path component associated with the second member; and an amplitude, a delay and/or a phase associated with a signal originating from the second member.

### Storage of Beacon Signal Information and Identity

The beacon associated information for example, attributes, almanac etc. can be:
Stored at: localisation management function, LMF, core network, CN, a central data base for example, Google, locally at BS, UE, could be held in the beacon itself (like speed limit road sign with limitation to night times . . . ), in a traffic light or other roadside furniture (the beacon itself contains the message)
Provided by/via: the beacon itself, an RRC connection, the BS (broadcast channels, user or user group specific channels), Sidelink (SL), within a closed subscriber group, the MNO wide, OTT or via internet access by an RAT external (auxiliary) entity, etc.

### Signalling Considerations

According to an embodiment, a member such as a UE may be equipped with the means to provide feedback of beacon information to the gNB, core network and/or LMC and LMF. This information is not limited to include: the number of beacons observed; the IDs of the beacons (perhaps limited to within a certain power level within a given impulse response); and an estimation as to whether the beacon ID is associated with a static or moving component or object in either two or three spatial dimensions. Similarly, the gNB can perform uplink observations of the PUSCH, PUCCH and/or RACH. This information can be stored locally or network-wide in for example a database managed by the LMF, LMC etc.

It may be of advantage that beacon devices provide for information via an active signal generated, for identifying an MPS as well as for positioning purposes.

According to an embodiment there is provided the wireless communication scenario, wherein the wireless communication scenario is configured for instructing at least one beacon to insert a beacon-specific information into a predetermined resource, e.g., a time and/or frequency resource of, e.g., a CORESET, wherein the beacon is configured to operate accordingly. That is, a base station may leave some specific resources unused and the beacon may insert its information and a member can use such received information. According to an embodiment there is provided the wireless communication scenario, wherein the member is configured for receiving the beacon-specific information and for using the beacon-specific information as an identifier that tags the path component.

According to an embodiment there is provided the wireless communication scenario, wherein the beacon-specific information is specific for a group of beacons or for an individual beacon. Such insertion may be orchestrated within the network to allow for multiple advantages.

According to an embodiment there is provided the wireless communication scenario of, wherein the member is configured for identifying the path component based on a received beacon-specific information, e.g., for communication purpose and/or for positioning purpose.

That is, A beacon may use space (time resources and/or frequency resources) of an empty or partially empty CORESET to add specific signals. The location may be known or expected at a receiver. If the signal space is well designed, then a receiver can distinguish between different MPCs, when receiving a superposition of a few or more than a few such signals. Such empty CORESETs could be provided by the gNB in regular intervals. Similar to almost blank subframes. Beacons may be synced to frame structure and optionally compensate for timing advance.

### Identification of Multipath Components in a Propagation Environment

For communication purposes and based on their availability within a given propagation, the information obtained from a beacon can be used to identify multipath components (MPCs) and from this, the stability of such MPCs can be determined. A number of examples are presented hereafter.

### Mitigation of CLI

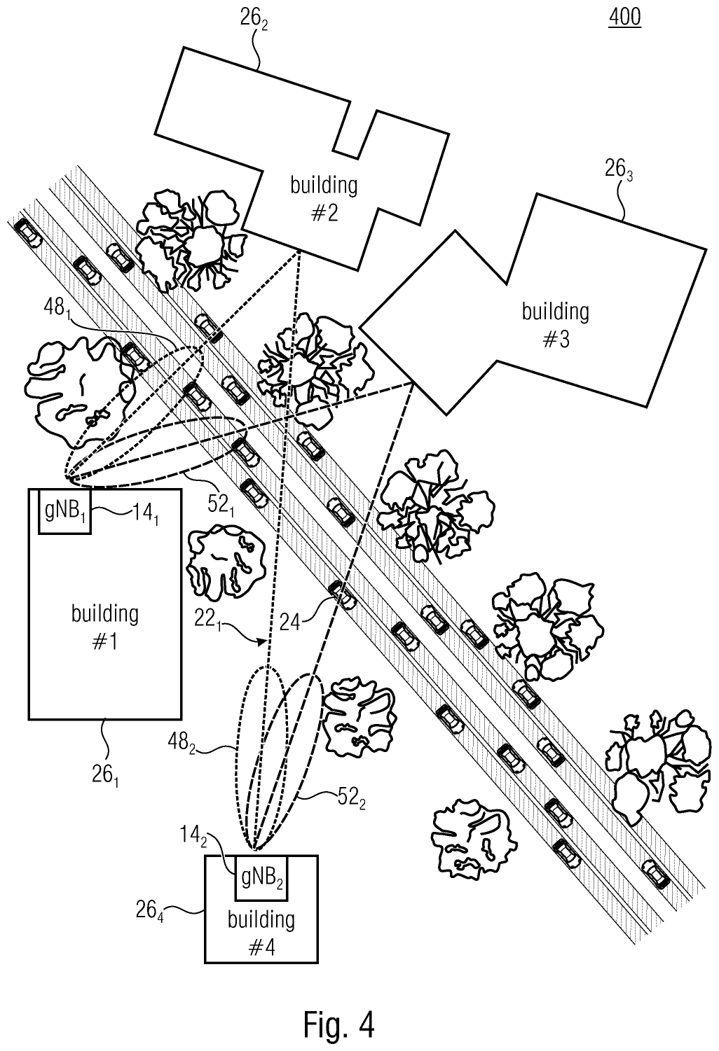

FIG. 4 shows a schematic block diagram of a wireless communication scenario 400 according to an embodiment, the scenario having two gNBs 14₁ and 14₂ operating on different TDD frame structures whereby cross-link interference (CLI) could be created. The gNBs 14₁, 14₂ may be operated by different MNOs in adjacent bands. To mitigate CLI, the gNBs may coordinate the use of their beams 48₁, 48₂, 52₁, and/or 52₂ using knowledge provided by the beacon-identified paths. Beams 48₁, 48₂, 52₁, and/or 52₂ each may be a transmission beam and/or a reception beam and are shown, as non-limiting example, to form beam pairs 48₁ and 48₂, on the one hand and 52₁ and 52₂ on the other hand, each pair having a transmission beam and a reception beam. For example, beams or path components may be tagged to inform other devices about the formed beam pairs. For example, a beaconing mechanism may indicate to one of the base stations 14₁ and/or 14₂ to not direct a transmission beam and/or a reception beam along a specific direction or path component to avoid interference.

### Communication Using MIMO

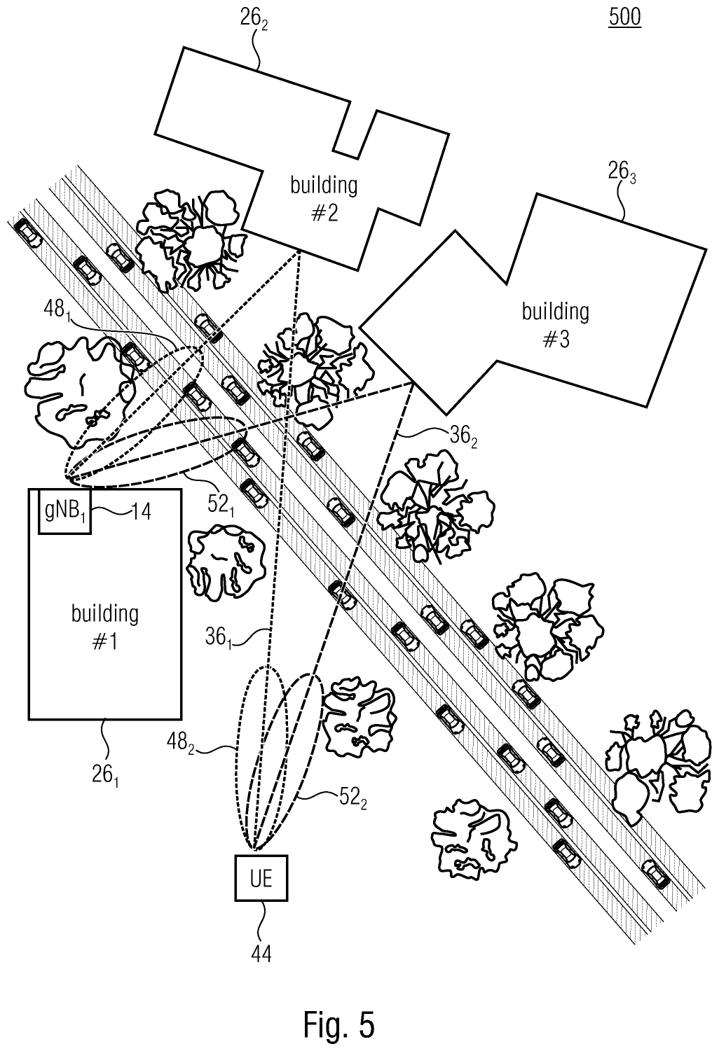

FIG. 5 shows a schematic block diagram of a wireless communication scenario 500 according to an embodiment, the scenario having, two gNB beams 48₁ and 52₁ point apart and communication via the two stable MPCs 36₁ and 36₂ allows MIMO to be used with a UE 44.

### Avoidance of Non-Stable Multipath Components

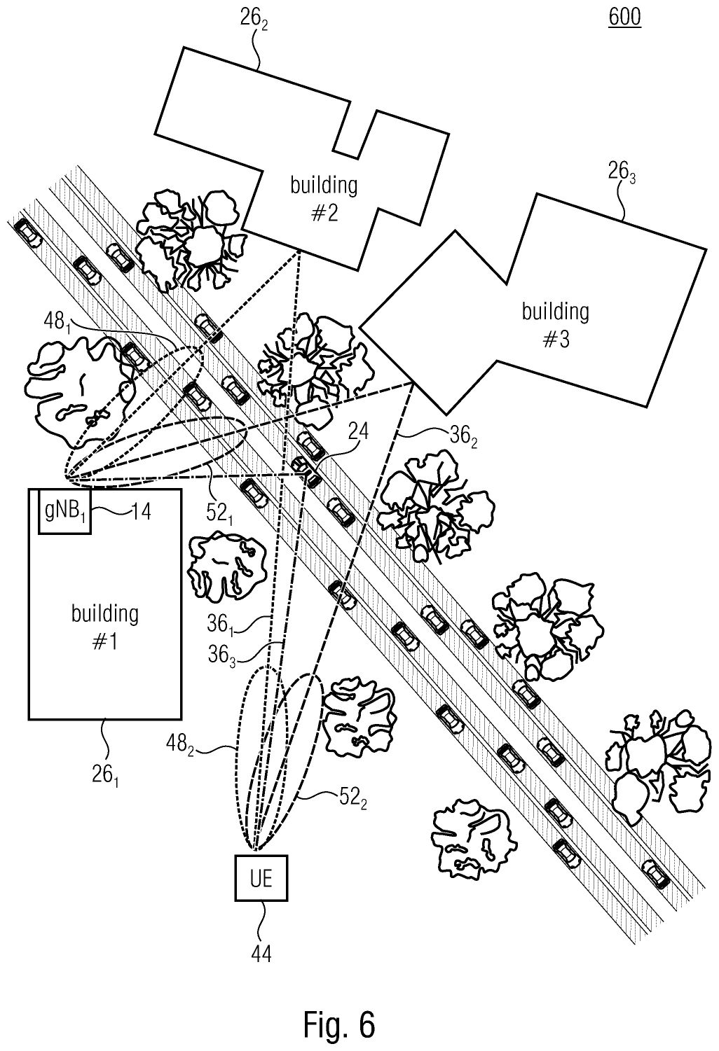

FIG. 6 shows a schematic block diagram of a wireless communication scenario 600 according to an embodiment, the scenario having both stable reflected signals travelling through MPCs 36₁ and 36₂ and a non-stable reflected signals travelling through path component 36₃. The vehicle 24 travelling in the direction from lower right to upper left is shown producing a reflected signal from UE beam 48₂ that falls outside the gNB beam 52₁. However, since the vehicle 24 is moving, the situation is likely to change. The identification of MPCs and/or a categorisation of the path component as being either stable or unstable allows receiving to better estimate the combination of antenna ports during signal detection.

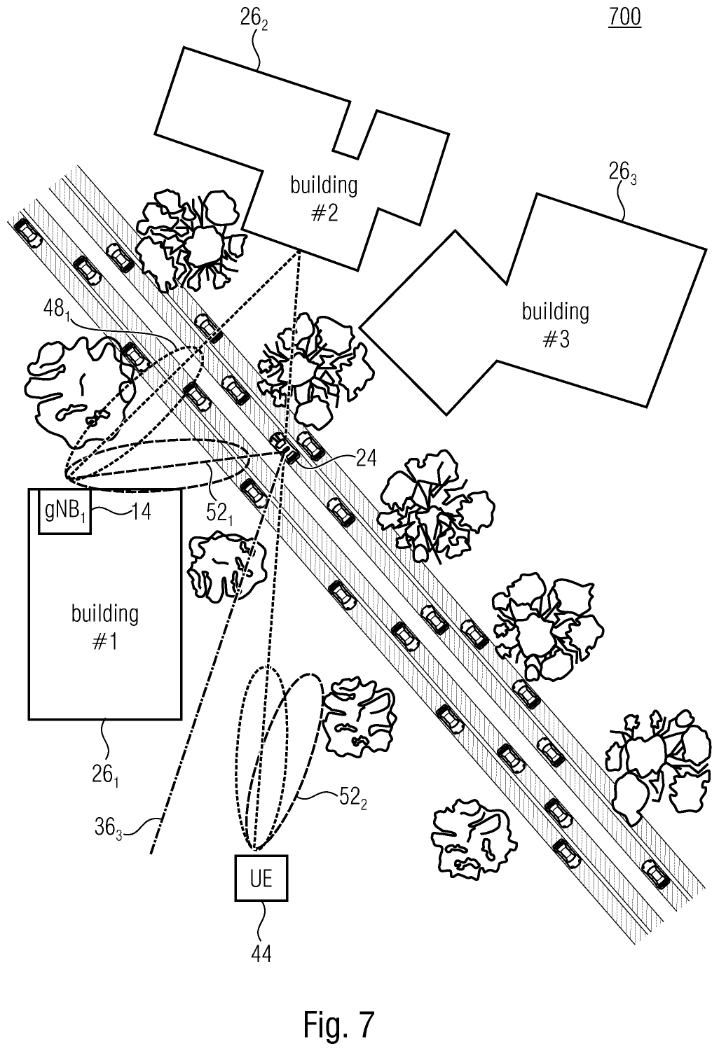

FIG. 7 shows a schematic block diagram of a wireless communication scenario 700 according to an embodiment, being similar to the scenario 600 with the exception that the car 24 has now moved some distance, creates a reflection and removes the (stable) reflection 36₂ from Building 26₃. The moving vehicle 24 thereby not only creates an unstable MPC 36₃ but also blocks a stable MPC 36₂. The reflection does not “find” or arrive at the UE 44, the gNB 14 respectively. Under these conditions the path 36₁ may be favoured by UE 44 and/or gNB 14. The gNB 14 and/or the UE 44 may track the availability and/or quality of a path component and may be aware in scenario 600 that both path components 36₁ and 36₂ are suitable. It may use both of them, e.g., exploiting a MIMO functionality and/or may select one of them already having selected the other as a fallback option or auxiliary solution to rely on in case, e.g., MPC 36₂ is selected and becomes unavailable.

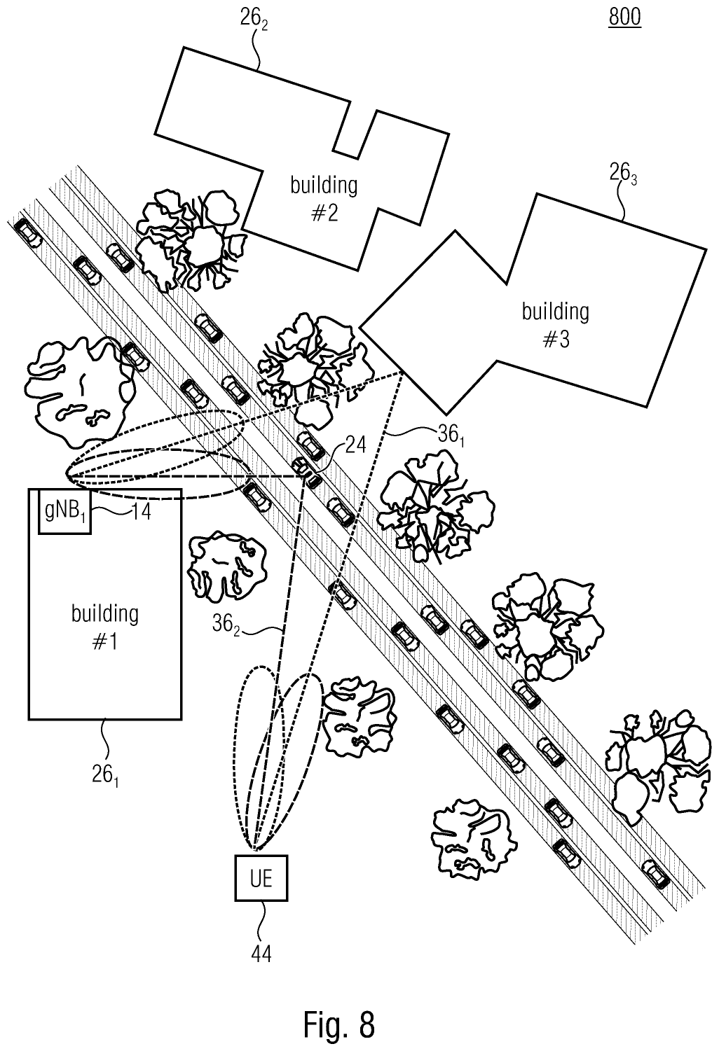

FIG. 8 shows a schematic block diagram of a wireless communication scenario 800 according to an embodiment. Therein a stable MPC from building 26₃ and a “dynamic” MPC 36₂ from the car 24 is available. The UE may use beacon-supplied information to identify the characteristics of the two MPCs 36₁ and 36₂ and thus opportunistically benefit from the scenario. For example, based on the beacon related information or the identifying of the path components 36₁ and 36₂, the UE may distinguish between both path components, e.g., to decide to not rely on the unstable or unknown path component 36₂ or to await a breakdown of said path component even if using it.

### Recognition of Identifiable Path Components

In the context of the invention disclosed herein, identifiable path components can be recognized using different means. For example, in addition to the identifiability of the path component being created by a passive or active beacon per se, the inventors have also recognized that a suitably equipped network entity might be able to recognize path components using different techniques. In this sense, the network entity does not need to rely on beacons to tag signals propagating over certain paths as it instead uses other means to estimate or recognize path components using for example optical techniques, including visible and non-visible methods. For example, a user equipment fitted with a camera and/or an electronically scannable antenna array can use electromagnetic sensing data to estimate the direction of arrival/departure of wave propagation.
Embodiments provide for a member using at least one visual image recognition technique (with and without the use of a database containing information location specific visual information) which allows a network entity to identify the objects in its surrounding environment such that it could estimate multipath components. In this sense, the network entity creates identifiable MPCs, IMPCs, without the use of beacons.
According to an embodiment, one or more suitable equipped network entities may combine their estimates of IMPCs in order to create a more reliable or accurate estimate of IMPCs, e.g., by exchanging information about the IMPCs and/or by storing such information in a common database.
   Two-Way Ranging with Obstructed Line-of-Sight

FIG. 9 shows a schematic block diagram of a wireless communication scenario 900 according to an embodiment. The scenario shows a two-way ranging example in an obstructed LOS (OLOS) environment. The figures shows that although is no LOS component available, there are however two distinct MPCs which are created by reflections from objects that are equipped with a beacon device. Localization of either device can be estimated using two-way ranging without an absolute timing reference point. If the position or location of one of the two devices is known then virtual triangulation via the virtual location reference points (“MPC beacons”) allows the location or position of the second device to be determined. Generally speaking, more than two MPCs (usually >3) are needed to accurately estimate a location in 3D space. According to an embodiment, the member or device 28, and/or 28₂ may determine its own position and/or the position of the respective other member 28₂, 28, respectively, based on a known position of a beacon 42₁ and/or 42₂ and based on a path component associated with the beacon 42₁ and/or 42₂ and/or multiple path components possibly associated with more than one beacon 42₁ and 42₂. At least one of beacons 42₁ and 42₂ may be implemented as a beacon 34.

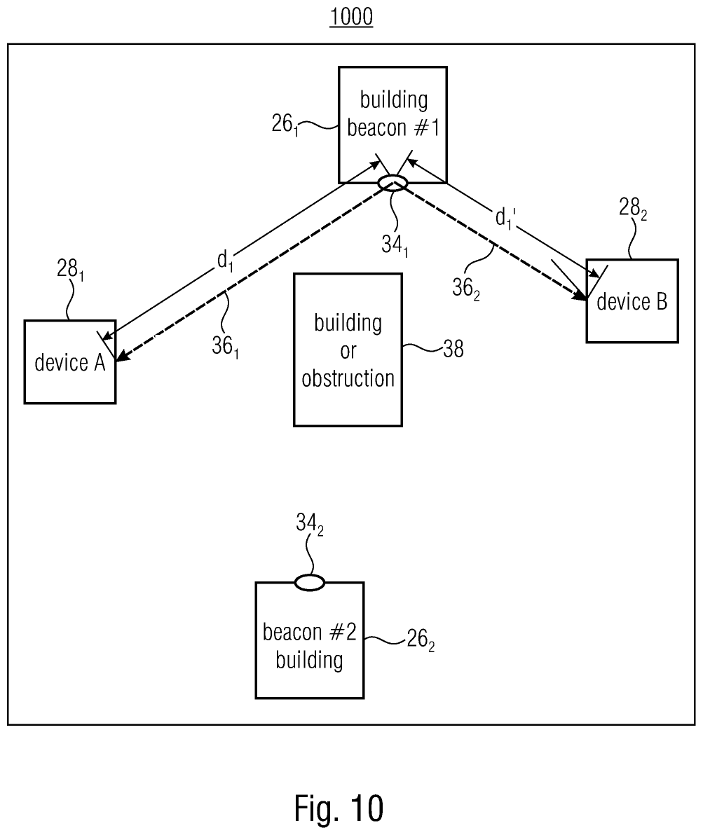

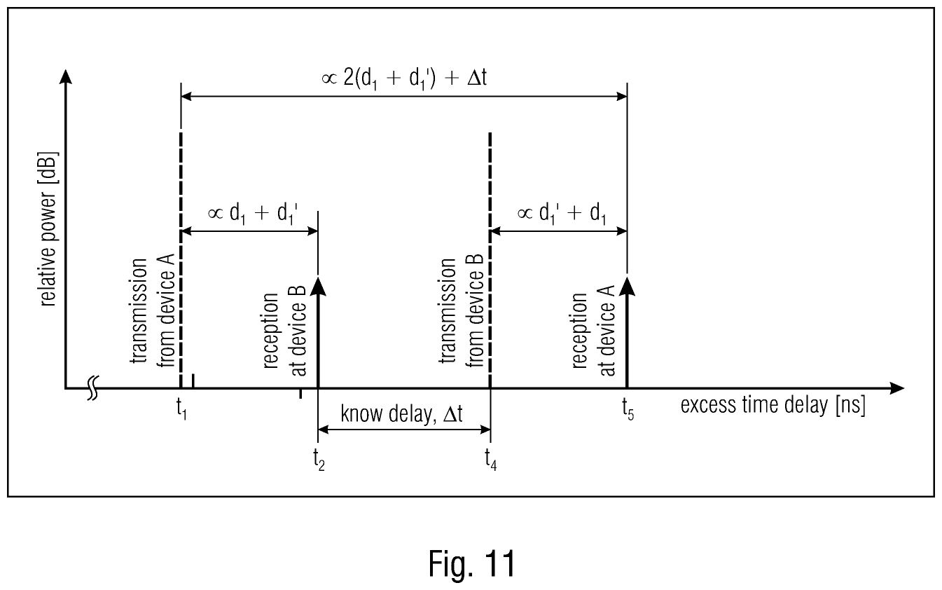

FIG. 10 shows a schematic block diagram of a wireless communication scenario 1000 according to an embodiment. Therein the geometrical arrangement of devices 28, obstacles 38 and beacons 34, and 34₂ is shown. This relates to the timing chart of FIG. 11 which shows an example of time sequence in a two-way ranging procedure and depicts a single bounce reflection or scattering at a building 28₁ (top of FIG. 10) that connects devices 26₁ (A) and 26₂ (B) via a first wireless link. The surface or area at which the reflection occurs may be marked by a beacon 34₁, thus allowing a receiver to relate this particular MPC 36₁, 36₂ respectively with a particular first specular reflection. The associated time sequence is shown in FIG. 11 whereby device A transmits 54 a signal at a time t₁. This signal is received after a time of flight (TOF) delay at a time t₂ at the receiver of device B, the time having lapsed being proportional to the sum of distances d₁ and d₁′. After a known delay Δt, device B may respond by transmitting a signal at a time t₄. This signal may be received by device A at a time t₅. Assuming that the paths from A to B and from B to A are reciprocal—that is, the components 36₁ and 36₂ via the first MPC (building 26₁ in FIG. 10)—and that the delay between the reception of the first transmit signal and the transmission of the second transmit signal is known, allows information of the two-way delay to be used to determine the corresponding distance d₁, d₁′ respectively. However, the actual location of device B remains uncertain and lies somewhere on a 3D-sphere (or 2D-circle when limited to a plane) which is centred around the MPC located at the top building in FIG. 10.

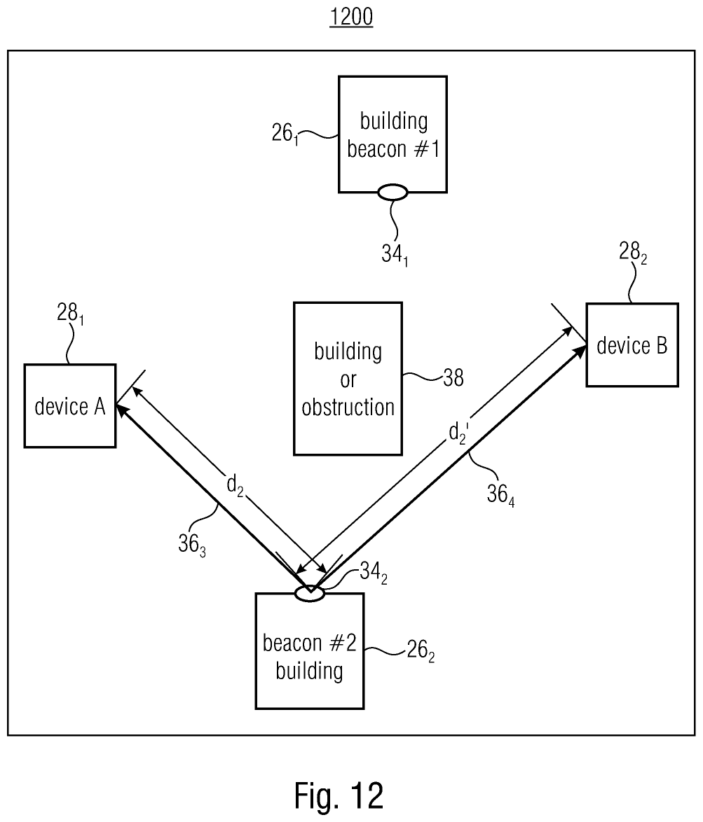

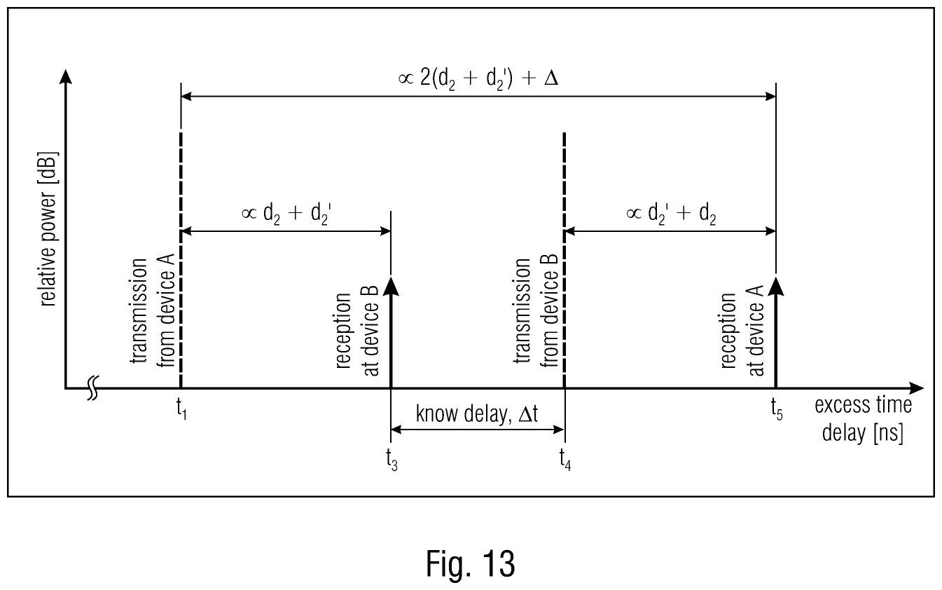

In FIG. 12, the geometrical arrangement of devices 28₁, 28₂, obstacles 38 and beacons 34₁, 34₂ of a wireless communication scenario 1200 is shown. This relates to the timing chart of FIG. 13 which shows an example of a time sequence in a two-way ranging procedure and depicts a single bounce reflection or scattering at the building 26₂ that connects devices A and B via a second wireless link different from the one in FIG. 10. The surface or area at which the reflection occurs is marked by a beacon 34₂, thus allowing a receiver to relate this particular MPC with a particular second specular reflection. The associated time sequence is shown in FIG. 13 whereby device A transmits a signal at time t₁. This is received after a time of flight (TOF) delay at the receiver of device B at time t₃. After a known delay Δt, device B responds by transmitting a signal at time t. This signal is received by device A at time t₆. Assuming that the paths from A to B and from B to A are reciprocal—that is, the components 36₃ and 36₄ via the second MPC (building 26₂ in FIG. 12)—and that the delay between the reception of the first transmit signal and the transmission of the second transmit signal is known, allows information of the two-way delay to be used to determine the corresponding distance d₂, d₂′ respectively. However, the actual location of device B remains uncertain and lies somewhere on a3D-sphere (or 2D-circle when limited to a plane) which is centred around the MPC located at the bottom building in FIG. 12.

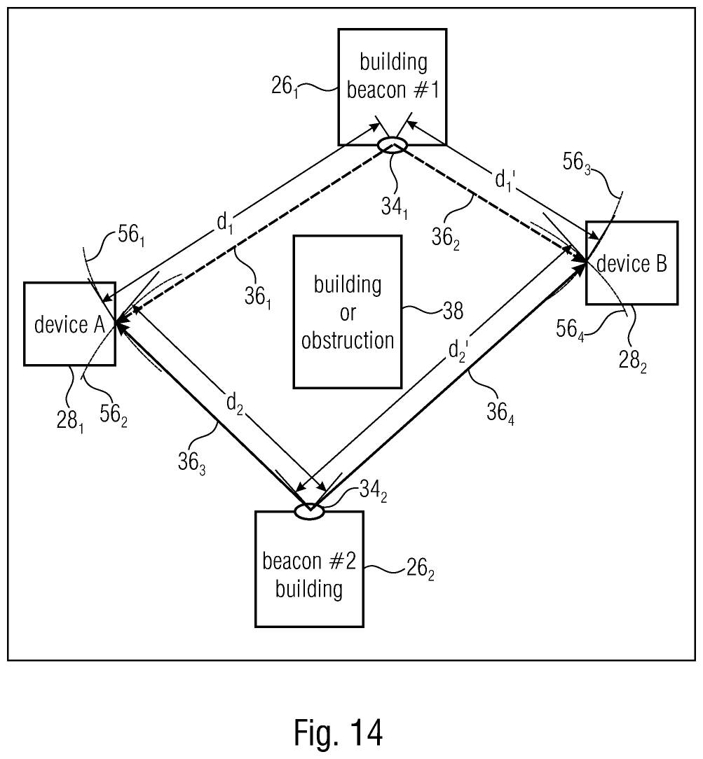

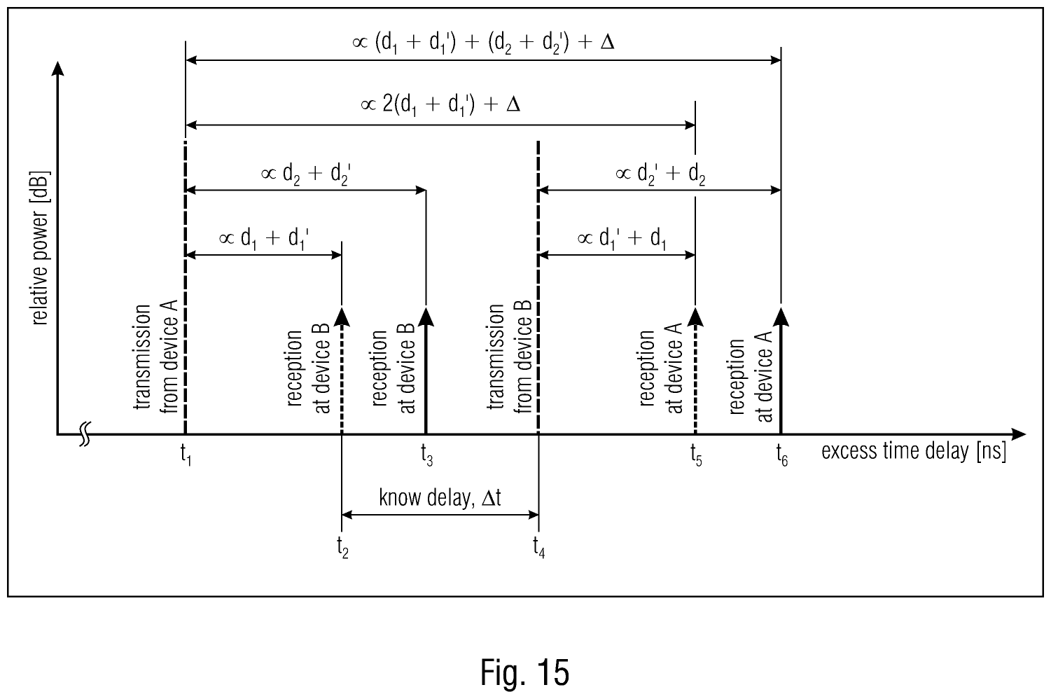

FIG. 14 shows a combination of FIG. 10 and FIG. 12 resulting in a wireless communication scenario 1400 according to an embodiment and shows the addition of intersecting arcs 56₁ to 56₄. Those arcs may represent a possible distance as a circle having a radius and the intersection may reduce or eliminate ambiguities to determine a distance, a relative position of one device relative to another or even an absolute position, e.g., based on knowledge about a beacon position. Since the position of each beacon 34₁ and 34₂ is known, the location of device A can be estimated given d₁ and d₂. Similarly, the location of device B can also be estimated given d₁′ and d₂′. The location estimation is improved by increasing the number of beacons and hence the number of paths utilized as virtual location reference points. For completeness, the associated timing chart is shown in FIG. 15 in which FIG. 11 and FIG. 13 are combined.

### Advantageous Combination of FR1 and FR2

1. Such a combination in accordance with embodiments may allow cross-carrier assistance. Use a first frequency range to obtain information regarding location and direction of MPCs for communication in a second frequency range—for example, FR1 and FR2.
2. Embodiments use FR1 and FR2 capabilities of a device to provide multiple estimations of position. Combine field-of-view (FOV) from each frequency range. Use knowledge of geometry and directions to increase the (time) resolution. (Assumption: the propagation channel for FR1 and FR2 is very similar at least in terms of the power delay profile (PDP)).
3. FR1 and FR2 features
a. Use FR2 beam sweeping to measure over different paths
b. Beams point in different directions
c. Use FR2 UE panels to measure over different paths

| | FR1 | FR2 |
|---|---|---|
| Different panels | Yes | Yes |
| Different beams from different | Unlikely | Yes |
| panels? | | |

### Controlling a Reconfigurable Signal Emitter

Whilst some embodiments proved for possibly passive structures that reflect a wireless signal in a wireless communication scenario, such structures possibly being marked with a beacon, other embodiments relate to a use of a reconfigurable signal emitter. Such embodiments may provide for a wireless communication scenario that uses at least three components at different locations to form an indirect communication, e.g., on a basis of a non-line-of-sight path, between at least two outer components or members and at least one intermediate component between the outer members. The intermediate component may be or may comprise a reconfigurable signal emitter which is described based on the example of a reconfigurable intelligent surface, RIS. However, other types of active and/or passive signal forwarders may be used as an alternative or in addition.

An example of a controllable signal emitter is presented herein through the use of a reconfigurable intelligent surface (RIS). The concept of a RIS may be understood to include, in connection with embodiments: a repeater, e.g., a standalone repeater or a network controlled repeater; a relay; an integrated access and backhaul (IAB) device; a sidelink relay; or a UE that provides beacon functionality and/or positioning information. For example, one possible difference between a relay and a repeater might be an optional implementation according to which a repeater relates to a device causing a comparatively short delay, e.g. using amplify and forward, whilst a or relay may provide other advantages, e.g., for the sake of causing a comparatively longer delay, e.g. digitize and forward, decode and forward, store and forward. Both components may form a part of a multipath component, in particular a strong multipath component which includes amplification and/or signal generation. This may include (bend-pipe) satellites, wherein a beacon can be induced by the source and/or the satellite acting as a relay and/or a repeater itself. Alternatively or in addition a RIS device may fall into one or both of those categories to benefit from beacons coming from the sources reflected at the RIS and/or signal modifications/additions created by the RIS or at the location of the RIS or nearby.

A prominent example of applying beacons in wireless communication using non-terrestrial network may relate to of at least the following members of a communication scenario:
a base station transmitting wireless signals to and receiving wireless signals from a satellite
a satellite (lower earth orbit, LEO, medium earth orbit, MEO or geostationary orbit, GEO) receiving wireless signals from a base station and forwarding (transmitting) the wireless signals to at least one receiving device, e.g. UE and/or receiving wireless signals from a transmitting device, e.g. UE and forwarding (transmitting) the wireless signals to at least one receiving device, e.g. base station
a device, e.g. user equipment (UE) communicating via at least one satellite with the at least one base station

Provided that in future satellite constellations in particular with hundreds or thousands of LEO satellites multiple base station via satellite path components can be made available to the user equipment. Such scenario provides for path diversity in a non-terrestrial communication scenario similar like in terrestrial cellular communication scenarios.

It may turn out to be beneficial to identify specific paths from a UE or base station perspective using beacons, wherein the obtained knowledge could be used for e.g. beam tracking at the transmitter and/or the receiver of the link and/or mapping of signals to be transmitted onto favourable/selected path components being a subset of all available path components (base station via sat to UE and reverse).

By exploiting beacon information for the above given communication tasks (beamtracking, beamforming, port mapping, port selection, path selection, path combining, etc.) the end to end communication link can be made more resilient and resources can be scheduled more efficiently, allowing improved resource utilization and larger link and/or system throughput.

In the above given examples the repeaters/relays may fulfil the general meaning of a multipath component, wherein a signal travels from a source (transmitter) to a destination (receiver) over multiple paths, wherein each path component forms a multi-path component (MPC) which may differ from other MPCs in signal strength, delay, signal distortion etc.

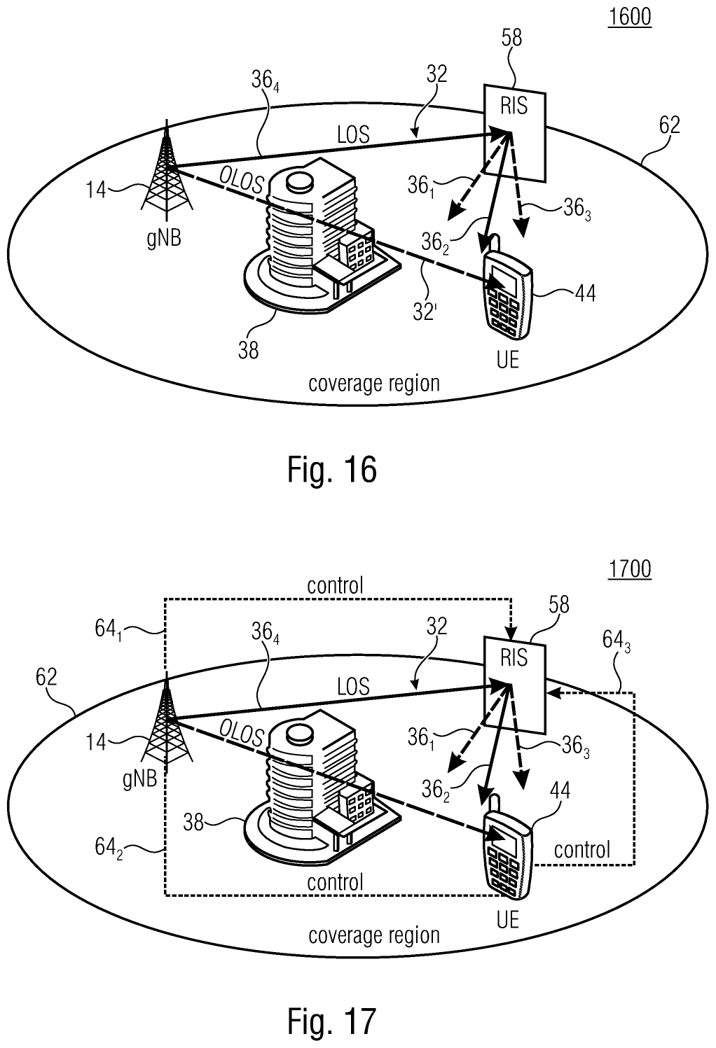

FIG. 16 shows a simplified perspective view of a wireless communication scenario 1600 according to an embodiment. The wireless communication scenario may comprise a basestation 14 (gNB) serving a coverage region 62, a building 38, a reconfigurable intelligent surface, RIS, 58 and a user equipment (UE) 44. The RIS may be is arranged so as to compensate for the obstructed line-of-sight (LOS) path 32′ between the gNB 14 and UE 44. The properties of the RIS 58 may allow it to be controlled in such a way that it reflects a signal coming from the gNB towards the UE and/or vice versa.

Although not shown, a beacon may be placed at or is in close proximity to the RIS. In other words, the beacon and RIS 58 may be exactly collocated or may deviate from such a positioning. For installations where the separation of the beacon and RIS 58 is in the order of a few metres and the members of the link are one or two orders of magnitude farther apart, such a non-collocation might be insignificant. In other applications however, especially those in which the frequency of operation is much higher, such as in the terahertz bands the offset between beacon and RIS 58 might need to be considered and perhaps compensated for. However, in a case where the RIS is able to implement a sort of tagging of the path component it provides, such a beacon may be optional.

The RIS 58 may therefore be seen as the combination of a known RIS together with the functionality of a beacon that provides positioning information. The latter can be derived from information made available by the network or from an almanac. For example, a known RIS or a RIS according to an embodiment is adjacently arranged with a beacon or a RIS in accordance with an embodiment may tag the path component.

FIG. 16 also depicts an obstructed line-of-sight (OLOS) path component 32′ from the gNB 14 to the UE 44 and a line-of-sight component 32 from the gNB 14 to the RIS 58. Further path components 36 are shown being emitted or provided or generated by the RIS 58, one of which is directed towards the UE 44, e.g., path component 36₂. While a single sense of direction is shown in FIG. 16, it should be noted that this is the for the ease of illustration only and that due to reciprocity, the paths may be bi-directional.

With reference to FIG. 16 and the path components 36₁ to 36₃ reflected from the RIS 58, only one of these is shown to reach the UE 44 since both the angle of incidence of the path component 36₄ (from gNB 14 to RIS 58) and the angle of reflection of the path component 36₂ (from RIS 58 to UE 44) are appropriately arranged so as to provide an effective (and reflected) communication path between gNB 14 and UE 44.

In other situations, an effective communication path between gNB 14 and UE 44 might not be immediately available. However, since the RIS is reconfigurable—that is to say, a property of the RIS 58 is configurable in view of and not limited to include one of direction, polarisation, frequency range of operation, transparency, reflectivity, refractivity—and together with knowledge of its existence and location, it can be adapted by way of controlling it to provide the effective path between gNB 14 and UE 44. To do so, according to embodiments, some form of control is implemented between the various elements comprising the wireless communication scenario 1700 of FIG. 17 that provides an example of control connections 64₁ to 64₃ between all elements, namely the gNB 14, the RIS 58 and the UE 44. A control connection may be implemented by transmitting a control signal, wherein such a control signal may be transmitted inband, e.g., using a wireless communication scheme or protocol of a network that is at the same time making benefit from the reconfigurable signal emitter but may also be transmitted over a different communication scheme, e.g., out-of-band or over a sidelink.

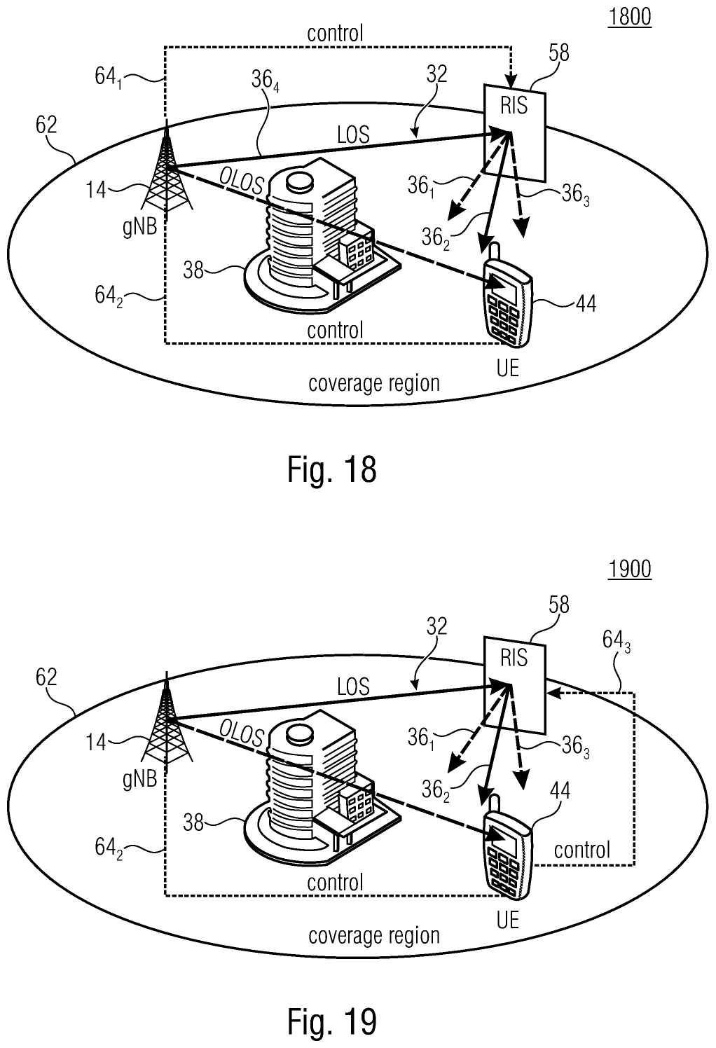

FIG. 18 shows a schematic perspective view of a wireless communication scenario 1800 that shows two control connections from the set shown in FIG. 17: one control connection 64₂ between the gNB 14 and UE 44; and the other control connection 64₁ between the gNB 14 and the RIS 58. For example, the gNB 14 may control the RIS 58 in view of at least one property and may receive, from the UE 44 a control signal or a feedback relating to the service or coverage the UE experiences from the RIS 58. Alternatively or in addition, the gNB 14 may use the control connection 64₂ to transmit information relating to the RIS 58 to the UE 44, e.g., to inform the UE about relevant parameters of the RIS 58, e.g., an identifier, a position, a capability or the like.

FIG. 19 shows a schematic perspective view of a wireless communication scenario 1900 that shows two control connections 64₂ and 64₃; the control connection 64₂ between the gNB and UE; and the control connection 64₃ between the UE 44 and the RIS 58. The latter may allow the UE 44 to control the behaviour of the RIS 58.

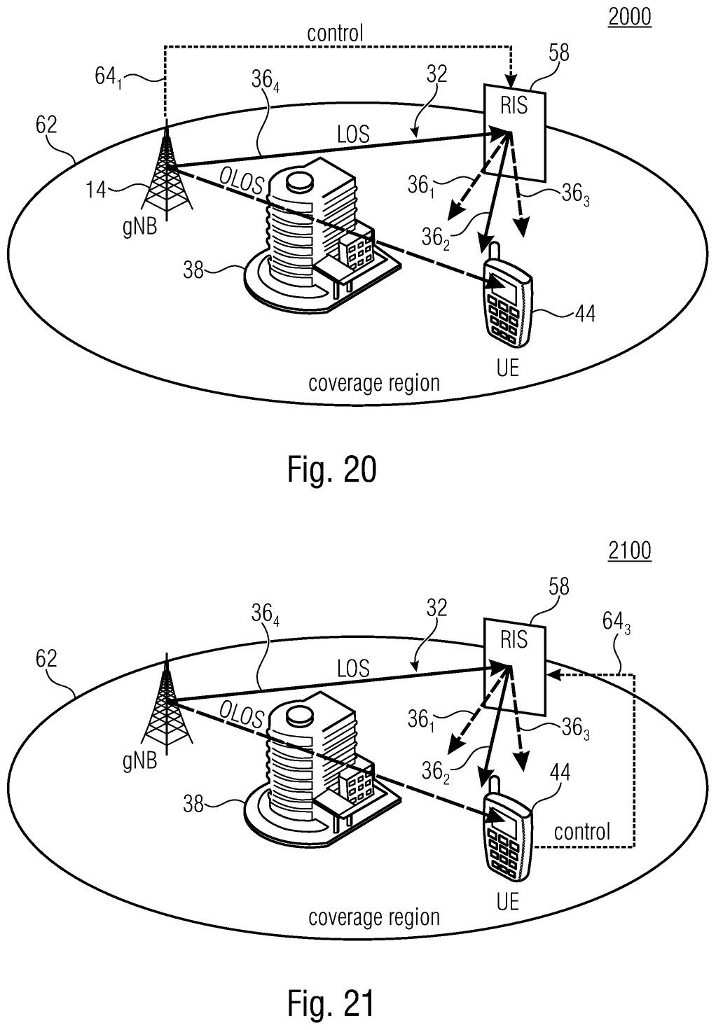

FIG. 20 shows a schematic perspective view of a wireless communication scenario 2000 that shows a use of a single control connection 64₁ between the gNB 14 and the RIS 58.

FIG. 21 shows a schematic perspective view of a wireless communication scenario 2100 that shows a use of a single control connection 64₃, this time between the UE 44 and the RIS 58.

According to an embodiment there is provided the wireless communication scenario, wherein the wireless communication scenario is configured for performing a beam alignment process by use of at least three distributed components for jointly forming an indirect communication, e.g., using a non-line-of-sight path, of the wireless communication scenario.

According to an embodiment there is provided the wireless communication scenario, wherein the at least three components comprise a first member, a second member and an intermediate component associated with the beacon to provide the path component.

According to an embodiment there is provided the wireless communication scenario, wherein the indirect communication comprises a reconfigurable signal emitter that can be, for example, a passive or active forwarder, as an intermediate component, the reconfigurable signal emitter configured for emitting an outgoing signal based on the incoming wireless signal;
wherein the wireless communication scenario is configured for changing a property of the reconfigurable signal emitter, e.g., a direction, polarisation, frequency range of operation, transparency and/or others as described, in accordance with a received control signal.

According to an embodiment there is provided the wireless communication scenario, wherein, to establish the indirect communication between a first member of the three distributed components and s second member of the three distributed components, the wireless communication scenario is configured for:
controlling a reconfigurable signal emitter as an intermediate component between the first member and the second member into a property in which the first member and the second member detect the identifier.

According to an embodiment there is provided the wireless communication scenario, wherein the first member is configured for controlling the reconfigurable signal emitter directly or indirectly, e.g., based on a report to the entity that really controls the surface, into different properties to obtain at least one first property or a set of first properties at which the first member detects the identifier;
wherein the second member is configured for controlling the reconfigurable signal emitter directly or indirectly, e.g., based on a report to the entity that really controls the surface into different properties to obtain at least one second property or a set of second properties at which the second member detects the identifier;
wherein the wireless communication scenario is configured for controlling the reconfigurable signal emitter into a property as an intersection of the first properties and second properties.

According to an embodiment there is provided the wireless communication scenario, wherein the wireless communication scenario is adapted for forming a plurality of beams having different beam directions for at least one position of the reconfigurable signal emitter to obtain a corresponding plurality of results, if the identifier is visible or not at the position of the reconfigurable signal emitter.

According to an embodiment there is provided the wireless communication scenario, wherein the reconfigurable signal emitter is one of an active signal forwarder and a passive signal forwarder.

According to an embodiment there is provided the wireless communication scenario, wherein the property relates to at least one of:
a direction of the incoming signal a direction of the outgoing signal
an orientation of a surface reflective for the incoming signal;
a transparency/reflectivity of a surface reflective for the incoming signal;
a refractive index of a surface refractive for the incoming signal;
a polarisation of the outgoing signal;
a frequency range processed for incoming signals or of outgoing signals
an attenuation of the outgoing signal;
a gain applied to the outgoing signal;
a phase change applied to the outgoing signal with respect to the incoming signal;
a selection of at last one array element of an antenna array of the intermediate component;
a shape or curvature of a reflective surface for reflecting the incoming signal

According to an embodiment there is provided the wireless communication scenario, wherein the intermediate component comprises a reconfigurable signal emitter, wherein for the beam alignment process, the reconfigurable signal emitter is controlled with regard to a first member that detects the identifier associated with the reconfigurable signal emitter and, sequentially or in parallel with regard to a second member that detects the identifier associated with the reconfigurable signal emitter to align beams of the first member and the second member to an indirect communication, e.g., a non-line-of-sight path.

According to an embodiment there is provided the wireless communication scenario, comprising, in a same path or in different paths to the member, at least two intermediate components each comprising a reconfigurable signal emitter, the wireless communication scenario adapted for commonly controlling the reconfigurable signal emitters.

According to an embodiment there is provided the wireless communication scenario, wherein the intermediate component is adapted to create a path component in the radio propagation environment.

According to an embodiment there is provided the wireless communication scenario, wherein the intermediate component comprises at least one of:
a reconfigurable intelligent surface, RIS;
a repeater;
a decode and forward relay
a digitize and forward relay
a store and forward relay
a bend-pipe satellite
an integrated access and backhaul, IAB, device;
a sidelink relay;
a user equipment, UE

According to an embodiment there is provided the wireless communication scenario, wherein the member and is a first member and wherein the wireless communication scenario comprises a second member communicating via the path component,
wherein the first member and the second member are configured for directly or indirectly exchanging information relating to an object or beacon in the wireless communication scenario being detectable for the first member and/or for the second member and for identifying the path component based on the object, e.g., associating the path component with a location of the object.

Embodiments described herein relate to a source of a wireless signal, e.g., a transmitter such as a base station, a UE, a relay, a repeater or other devices that are configured for operating in a wireless communication scenario. Such a device may be configured for selectively tagging a signal transmitted by the device when directing the signal along a predetermined path in the wireless communication scenario and with a tag that is associated with the path. That is, in knowledge about using a specific path or a component thereof, the device may implement a tag to tag the signal when being received at a sink or receiver. The device may be configured for not using the tag or for not tagging the signal transmitted along a different path. This may result in different copies of a same signal being transmitted over different paths in a multipath environment wherein at least one of the copies is tagged and at least one copy is not tagged, which may not only allow to distinguish between tagged/untagged paths but optionally also between paths comprising different tags. For example, a subset of transmitted signals or copies may be tagged whilst a different subset may be untagged. For example, a transmitter knowing to transmit, with a specific beam, e.g., a narrow beam, towards a reflector, beacon or the like may use an associated tag.

Such a capability may result in a situation at the receiver where different signals received from a same intermediate component are tagged differently which may result in beneficial information at the receiver.

Placement of the Solution Components within a 3GPP-Type Framework

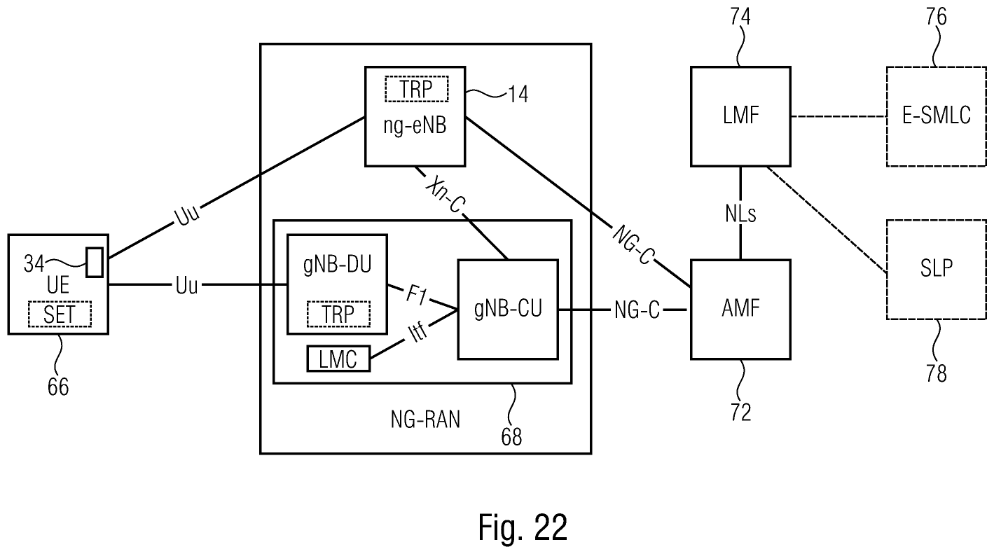

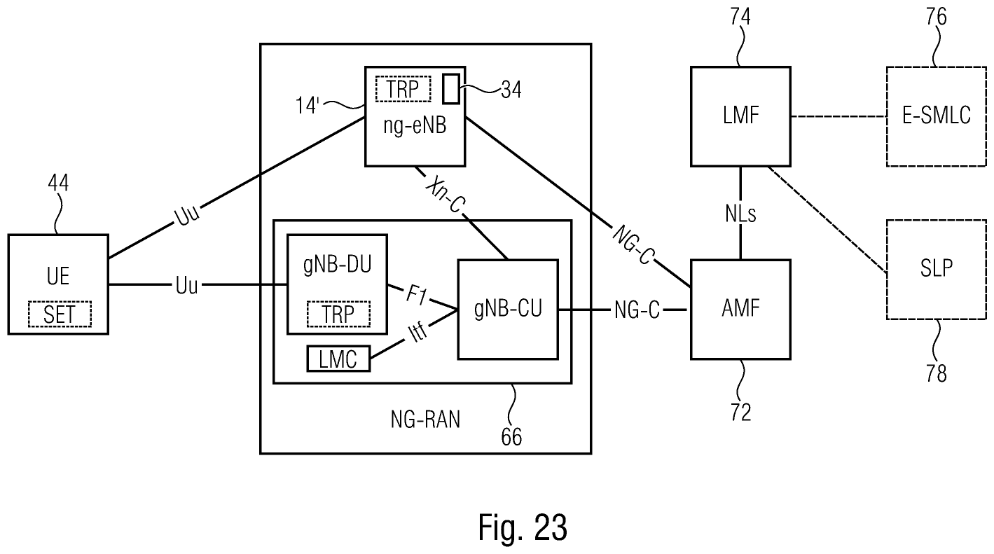

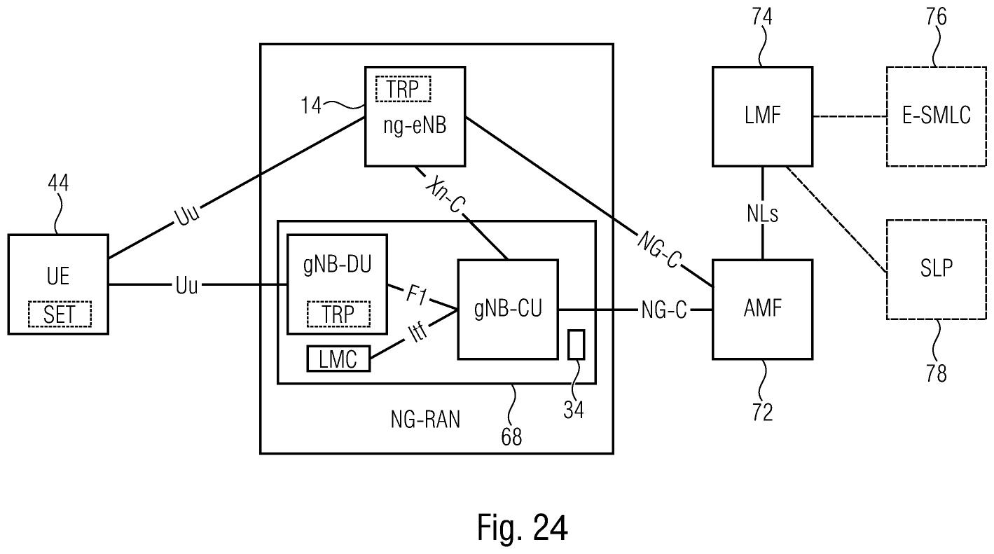

In the following, examples of the placement of the solution components within a 3GPP-type framework are presented graphically. FIG. 22, FIG. 23 and FIG. 24 each show an identifiable beacon associated or embedded with the UE, the ng-eNB and the gNB. In contrast to the existing 3GPP framework—in which only a cell identifier or UE identifier is made available by gNB and UE alike—the beacon either directly or indirectly provides information relating to its position and/or location. When this is provided indirectly, a network entity uses knowledge of the beacon identity to access a database or almanac.

FIG. 22 shows a schematic bloc diagram of an example arrangement of functional entities (for communication and/or positioning purposes) in which a UE 66 according to an embodiment is providing an identifiable beacon 34 to enhance the reference structure shown in 3GPP TR 38.856—original caption “Alternative 2—LMC as logical node within split gNB”). Communication to NG RAN may incorporate a use of a Uu interface, e.g., to reach a transmission reception point, TRP, of gNB 14 or a distributed unit, DU, thereof 68, the NG-RAN able to optionally further communicate with Access and Mobility Management Function, AMF, 72, LMF 74, Evolved Serving Mobile Location Centre, E-SMLC76, an SUPL Location Platform (SLP) 78.

FIG. 23 shows a schematic bloc diagram of an example arrangement of the functional entities (for communication and/or positioning purposes) in which the ng-eNB 14′ is providing an identifiable beacon 34 to enhance the reference structure shown in 3GPP TR 38.856—original caption “Alternative 2—LMC as logical node within split gNB”.

FIG. 24 shows a schematic bloc diagram of an example arrangement of the functional entities (for communication and/or positioning purposes) in which the which the gNB 68′ is providing an identifiable beacon 34 to enhance the reference structure shown in 3GPP TR 38.856—original caption “Alternative 2—LMC as logical node within split gNB”.

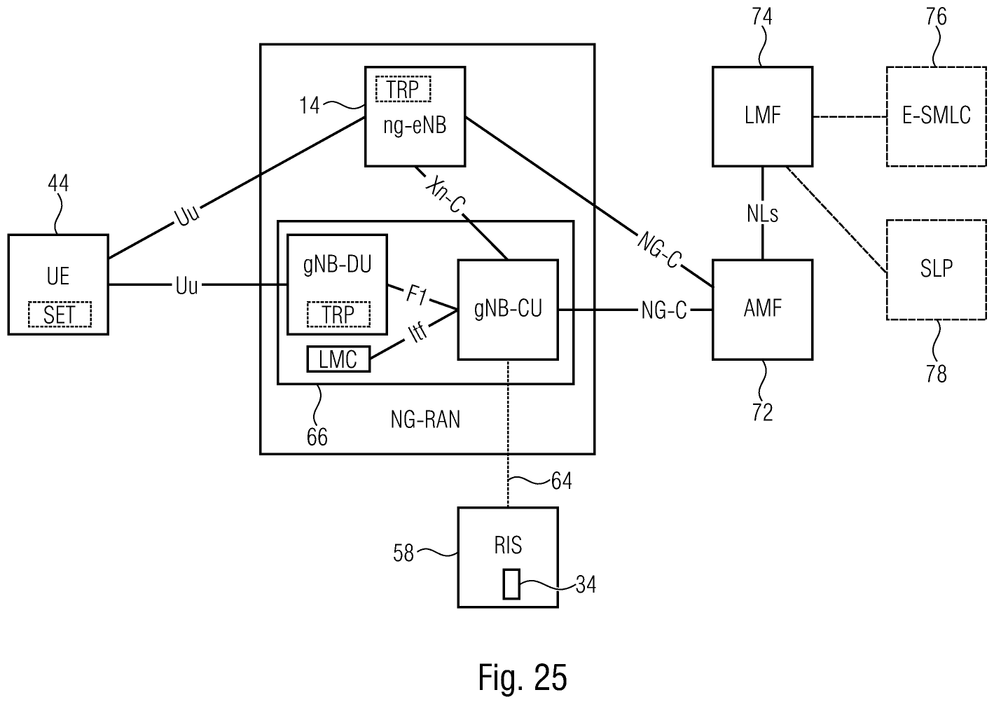

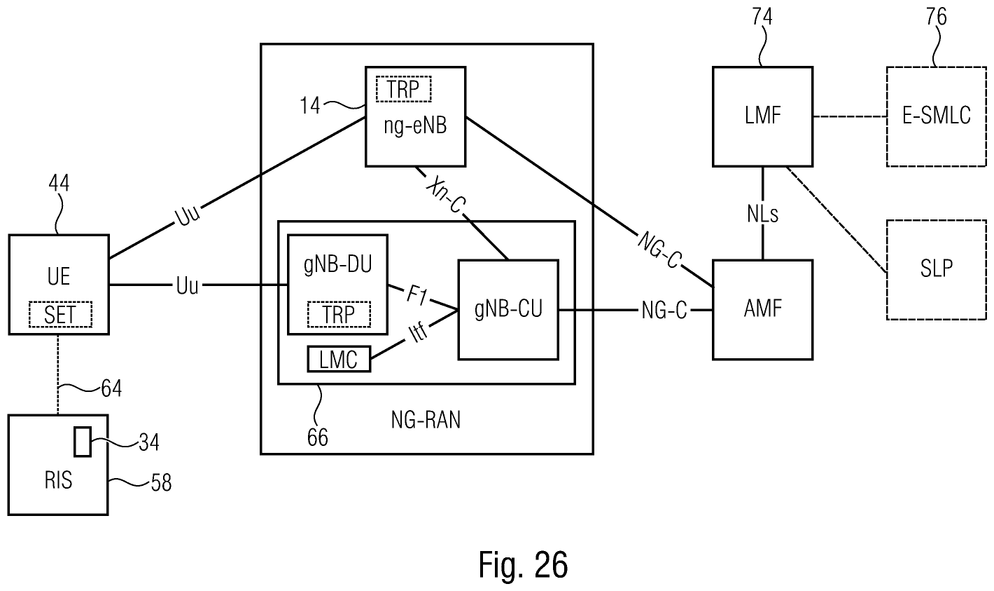

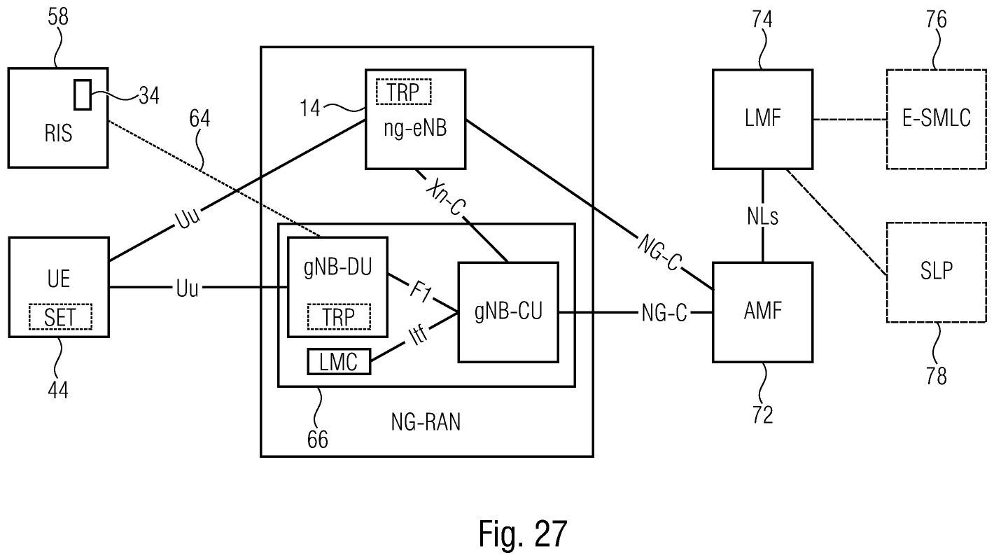

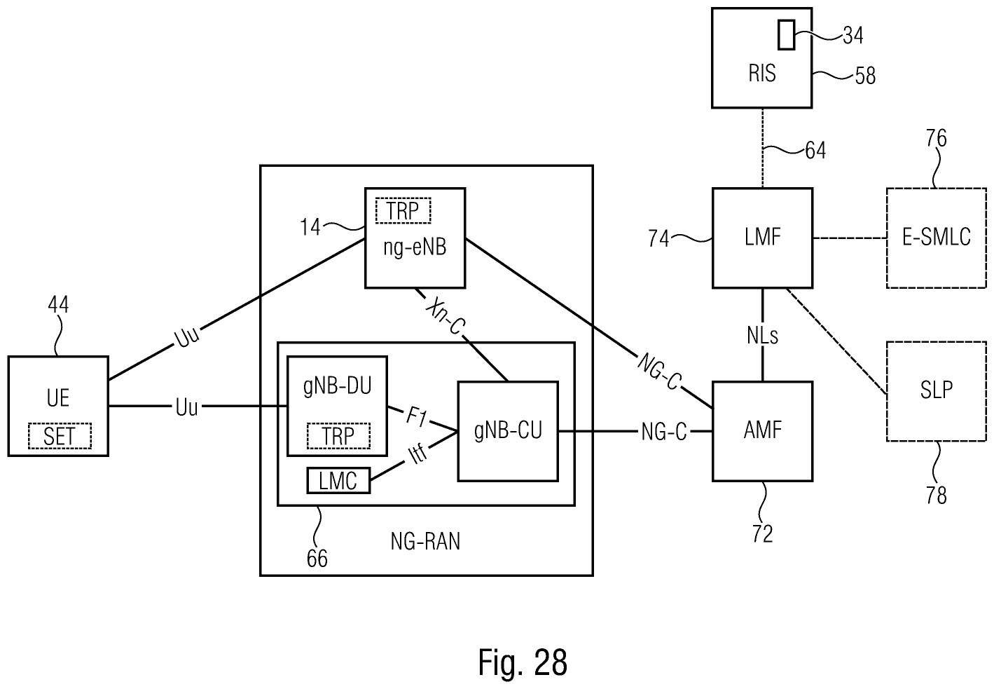

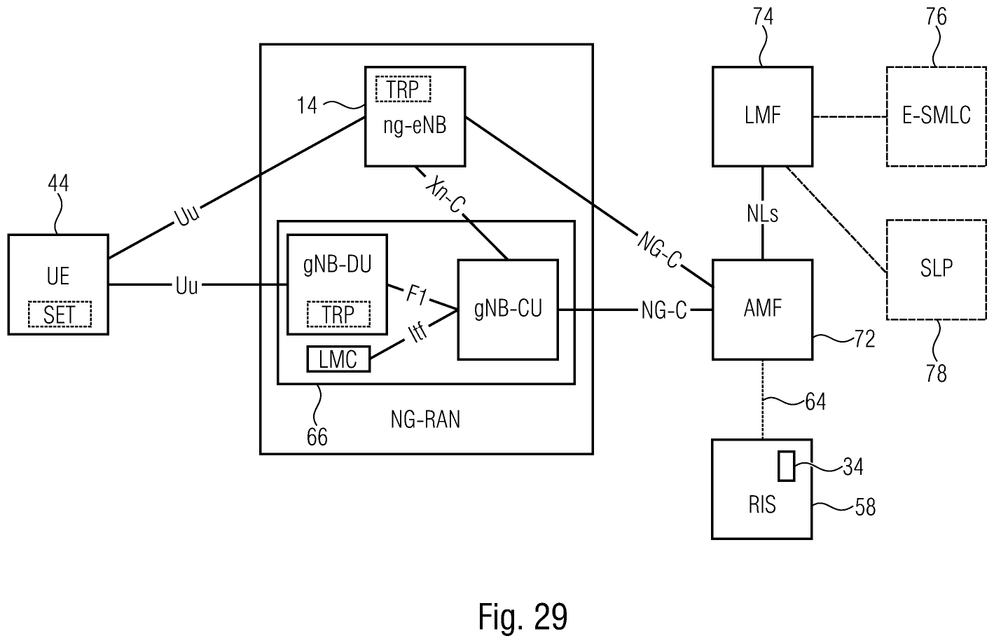

FIG. 25, FIG. 26, FIG. 27, FIG. 28 and FIG. 29 show examples of a RIS 58 and an identifiable beacon 34 associated with various network components. As before, the beacon 34 either directly or indirectly provides information relating to its position and/or location. Beyond the examples shown above, the RIS 58 may be arranged to be controlled or configured by different entities. The connection 64 can be wired or wireless using standard interfaces (e.g. Uu, sidelink, Xn, NG-C, etc.) or future-defined interfaces (e.g. a new radio control channel). In addition to the specific examples shown in the figures, further combinations are not excluded.

FIG. 25 shows an schematic block diagram of a wireless communication scenario having an arrangement of the functional entities used for communication and/or positioning purposes including a RIS 58 and an identifiable beacon 34. The RIS 58 is connected to the gNB-CU via control connection 64.

FIG. 26 shows an schematic block diagram of a wireless communication scenario having an arrangement of the functional entities used for communication and/or positioning purposes including a RIS 58 and an identifiable beacon 34. The RIS 58 is connected to the UE via control connection 64.

FIG. 27 shows an schematic block diagram of a wireless communication scenario having an example arrangement of the functional entities used for communication and/or positioning purposes including a RIS 58 and an identifiable beacon 34. The RIS 58 is connected to the gNB-DU via control connection 64.

FIG. 28 shows an schematic block diagram of a wireless communication scenario having an example arrangement of the functional entities used for communication and/or positioning purposes including a RIS 58 and an identifiable beacon 34. The RIS 58 is connected to the LMF via control connection 64.

FIG. 29 shows an schematic block diagram of a wireless communication scenario having an example arrangement of the functional entities used for communication and/or positioning purposes including a RIS 58 and an identifiable beacon 34. The RIS 58 is connected to the AMF via control connection 64.

Further embodiments relate to active beacons, to passive beacons, to a beacon almanac, its content, format, accuracy and/or resolution, they relate to controlling an axis to such a database and where to store the information, e.g., distributed in a cloud or locally. Embodiments also relate to a combination or federation of databases that connect information of different entities.

According to an embodiment there is provided, a wireless communication scenario comprising a radio propagation environment providing for a propagation of a wireless signal via a path component, the wireless communication scenario comprising:
a plurality of devices configured for wirelessly communicating in the wireless communication scenario;
wherein a member of the wireless communication scenario is configured for identifying the path component of the wireless signal travelling through the radio propagation environment.

According to an embodiment there is provided the wireless communication scenario, wherein the wireless communication scenario is adapted for a propagation of the wireless signal via a single path component or via a multiple path components within a multipath propagation environment.

According to an embodiment there is provided the wireless communication scenario, wherein the member is configured for receiving the wireless signal and an identifier and for deriving, based on the identifier, that the wireless signal was received via the path component.

According to an embodiment, the wireless communication scenario comprises at least one beacon related to an object in the radio propagation environment or related to a signal property of a wireless signal, the beacon configured for providing the identifier that tags the path component. For example, the signal and/or the beacon may be associated, with the path component such that detection of the signal property, e.g., an information therein, a phase, an amplitude thereof or the like, is associated in the wireless communication scenario with the path component, e.g., a spatial information may be available whether the path component is available at the current position and/or where the path component is available.

According to an embodiment there is provided the wireless communication scenario, wherein the wireless communication scenario is configured for:
tagging the path component with an identifier associated with the path component;
identifying the path component based on the identifier.

According to an embodiment there is provided the wireless communication scenario, wherein the wireless communication scenario comprises at least one beacon related to an object in the radio propagation environment that modifies an incoming wireless signal, the beacon configured for providing the identifier that tags the path component.

According to an embodiment, the wireless communication scenario comprises at least one beacon related to a plurality of objects forming a group of objects in the radio propagation environment the group of objects tagging an outgoing wireless signal, the beacon configured for providing the identifier that tags the path components associated with the group of objects.

According to an embodiment, the at least on beacon is a plurality of beacons the plurality of beacons being identical, partially different or different for:
each individual object of the group of objects;
all individual objects of the group of objects
or at least one subset of the group of objects.

That is, one, a subset or all of the objects may differ or be equal in a respective property, a behaviour that may be known at least by the receiver and/or stored in a database/almanac to allow for a precise tagging.

According to an embodiment, the wireless communication scenario comprises at least one beacon related to an object in the radio propagation environment that modifies at least one incoming wireless signal, the beacon configured for providing the identifier that tags the path components associated with the at least one incoming wireless signal, wherein the object is located along at least one propagation path from a source to a destination of the at least one incoming wireless signal.

According to an embodiment, the wireless communication scenario comprises at least one beacon related to a multitude of objects forming a group of objects in the radio propagation environment the group of objects modifying at least one incoming wireless signal, the beacon configured for providing the identifier that tags the path components associated with the at least one incoming wireless signal, wherein the group of objects is located along at least one propagation path from a source to a destination of the at least one incoming wireless signal, wherein the at least on beacon is a plurality of beacons the plurality of beacons being identical, partially different or different for:
identical, identical in parts or different for:
   each individual object of the group of objects;
   all individual objects of the group of objects
   or at least one subset of the group of objects OR
   each source of the at least one incoming wireless signals.

According to an embodiment there is provided the wireless communication scenario, wherein the beacon is configured for providing the identifier as at least a part of at least one of:
an optical signal;
an acoustic signal;
a visible or non-visible signal with respect to a human eye;
an inband signal;
an out-of-band signal transmitted by the beacon and being out-of-band with regard to the incoming signal;
an out-of-frame signal being out-of-frame with regard to a frame of an outgoing signal being based on the incoming signal;
out-of-slot signal being out-of-slot with regard to a slot of an outgoing signal being based on the incoming signal;
out-of-channel signal being out-of-channel with regard to a channel of an outgoing signal being based on the incoming signal;
out-of-bandwidthpart, BWP signal being out-of-BWP with regard to a BWP of an outgoing signal being based on the incoming signal;
as a signal in an uplink slot, e.g., as a base station;
a pattern or structure of the beacon;
a shape of the object or of the beacon;
a modification applied to the incoming wireless signal by the object, e.g., as a passive beacon that may change, e.g., a polarization, a phase and/or an amplitude
an information included by the beacon into the incoming wireless signal.

According to an embodiment there is provided the wireless communication scenario, wherein the device is configured for including an information included by the beacon into the incoming wireless signal to implement the modification; wherein the information is associated with the beacon and comprises at least one of:
an identifier of the beacon;
an identifier per beam direction of the beacon;
a location of the beacon; or
an operation mode of the beacon.
A frame structure of the beacon
A sync structure of the beacon e.g. PSS; SSS

According to an embodiment there is provided the wireless communication scenario, wherein the identifier of the beacon is updated according to a condition or requirement.

According to an embodiment there is provided the wireless communication scenario, wherein the wireless communication scenario is configured for instructing at least one beacon to insert a beacon-specific information into a predetermined resource, e.g., a time and/or frequency resource of, e.g., a CORESET, a DCI, MIB and/or SIB, wherein the beacon is configured to operate accordingly.

According to an embodiment there is provided the wireless communication scenario, wherein the member is configured for receiving the beacon-specific information and for using the beacon-specific information as an identifier that tags the path component.

According to an embodiment there is provided the wireless communication scenario, wherein the beacon-specific information is specific for a group of beacons or for an individual beacon.

According to an embodiment there is provided the wireless communication scenario of, wherein the member is configured for identifying the path component based on a received beacon-specific information.

According to an embodiment there is provided the wireless communication scenario of, wherein the beacon is configured for providing the identifier based on a spatial pattern comprising at least three reference markers being spatially distributed, wherein the member is configured for determining a relative orientation toward the spatial pattern based on the spatial pattern and for identifying the path component based on the relative orientation.

According to an embodiment there is provided the wireless communication scenario, wherein the beacon is configured for providing the identifier for tagging an outgoing wireless signal that is based on the incoming wireless signal;
wherein at least one member of the wireless communication scenario is configured for identifying the path component using the tag.

According to an embodiment there is provided the wireless communication scenario, wherein the beacon is configured for providing the identifier synchronized to the wireless communication and/or responsive to a received trigger.

According to an embodiment there is provided the wireless communication scenario, comprising a database having stored therein a plurality of identifiers and an associated set of identifier information that contains information associated to a beacon providing the identifier.

According to an embodiment there is provided the wireless communication scenario, wherein the beacon is configured for providing a modified wireless signal as an outgoing signal based on an incoming wireless signal by implementing a modification of the incoming wireless signal generating the second wireless signal, the modification being associated with the beacon to associate the path component with the beacon.

According to an embodiment there is provided the wireless communication scenario, wherein the beacon is configured for providing the modification during operation in a beaconing mode; wherein the beacon is configured for starting and/or ending the beaconing mode responsive to an external stimulus.

According to an embodiment there is provided the wireless communication scenario, wherein the external stimulus comprises at least one of:
a sequence or control signal received from the wireless communication scenario;
a position of the beacon;
an energy level of a battery of the beacon and/or an access to energy supply, e.g., energy harvesting

According to an embodiment there is provided the wireless communication scenario, wherein the modification relates to at least one of:
a periodicity used for transmitting signals;
a directionality used for transmitting the second wireless signal,
a polarization used for transmitting the second wireless signal,
a change of polarisation between the first wireless signal and the second wireless signal;
sequences used for transmitting the second wireless signal,
radio beam patterns used for transmitting the second wireless signal,
a temporal availability and/or validity for transmitting the second wireless signal,
a frequency range used for transmitting the second wireless signal,
a signal strength used for transmitting the second wireless signal, a code used for transmitting the second wireless signal,
a signature used for transmitting the second wireless signal,
a reference signal used for transmitting the second wireless signal, and
a radar cross-section of the device
including information into the second wireless signal that indicates information associated with the device.
a reflection coefficient implemented by the device;
a distribution or probability of blockage for the first and/or second wireless signal;
a phase shift, a phase modulation or an amplitude modulation on the first signal before the transmitting the second signal.

According to an embodiment there is provided the wireless communication scenario, wherein the beacon and/or the member and/or a different device is configured for storing information associated with the beacon in a database, e.g., a beacon register, e.g., an almanac, of the wireless communication scenario.

According to an embodiment there is provided the wireless communication scenario, wherein the beacon and/or the member and/or a different device is configured for reporting the information associated with the beacon to the wireless communication scenario.

According to an embodiment there is provided the wireless communication scenario, wherein the beacon and/or the member and/or a different device is configured for reporting the information associated with the beacon directly to other network entities, e.g., gNBs, UEs, LMF/LMC, or other higher layer entities including databases and application programs.

According to an embodiment there is provided the wireless communication scenario, wherein the beacon is configured for reporting the information associated with the device using a radio resource control, RRC, connection, a base station, e.g., a broadcast channel, a user specific channel or a user group specific channel, a Sidelink, SL, a channel within a closed subscriber group, the MNO wide service an over the op, OTT, communication, the internet, e.g., using an access by a radio access technology, RAT, of an external entity.

According to an embodiment there is provided the wireless communication scenario, wherein the beacon is configured for implementing a plurality of modifications and to generate outgoing wireless signal based on a selection of the modification from the plurality of modifications; wherein the beacon is configured for selecting the modification and/or for receiving a signal indicating the modification and for operating accordingly.

According to an embodiment there is provided the wireless communication scenario, wherein the wireless communication scenario is configured for performing a beam alignment process by use of at least three distributed components for jointly forming an indirect communication, e.g., using a non-line-of-sight path, of the wireless communication scenario.

According to an embodiment there is provided the wireless communication scenario, wherein the at least three components comprise a first member, a second member and an intermediate component associated with the beacon to provide the path component.

According to an embodiment there is provided the wireless communication scenario, wherein the indirect communication comprises a reconfigurable signal emitter that can be, for example, a passive or active forwarder, as an intermediate component, the reconfigurable signal emitter configured for emitting an outgoing signal based on the incoming wireless signal;
wherein the wireless communication scenario is configured for changing a property of the reconfigurable signal emitter, e.g., a direction, polarisation, frequency range of operation, transparency and/or others as described, in accordance with a received control signal.

According to an embodiment there is provided the wireless communication scenario, wherein, to establish the indirect communication between a first member of the three distributed components and s second member of the three distributed components, the wireless communication scenario is configured for:
controlling a reconfigurable signal emitter as an intermediate component between the first member and the second member into a property in which the first member and the second member detect the identifier.

According to an embodiment there is provided the wireless communication scenario, wherein the first member is configured for controlling the reconfigurable signal emitter directly or indirectly, e.g., based on a report to the entity that really controls the surface, into different properties to obtain at least one first property or a set of first properties at which the first member detects the identifier;
wherein the second member is configured for controlling the reconfigurable signal emitter directly or indirectly, e.g., based on a report to the entity that really controls the surface into different properties to obtain at least one second property or a set of second properties at which the second member detects the identifier;
wherein the wireless communication scenario is configured for controlling the reconfigurable signal emitter into a property as an intersection of the first properties and second properties.

According to an embodiment there is provided the wireless communication scenario, wherein the wireless communication scenario is adapted for forming a plurality of beams having different beam directions for at least one position of the reconfigurable signal emitter to obtain a corresponding plurality of results, if the identifier is visible or not at the position of the reconfigurable signal emitter.

According to an embodiment there is provided the wireless communication scenario, wherein the reconfigurable signal emitter is one of an active signal forwarder and a passive signal forwarder.

According to an embodiment there is provided the wireless communication scenario, wherein the property relates to at least one of:
a direction of the incoming signal
a direction of the outgoing signal
an orientation of a surface reflective for the incoming signal;
a transparency/reflectivity of a surface reflective for the incoming signal;
a refractive index of a surface refractive for the incoming signal;
a polarisation of the outgoing signal;
a frequency range processed for incoming signals or of outgoing signals
an attenuation of the outgoing signal;
a gain applied to the outgoing signal;
a phase change applied to the outgoing signal with respect to the incoming signal;
a selection of at last one array element of an antenna array of the intermediate component;
a shape or curvature of a reflective surface for reflecting the incoming signal

According to an embodiment there is provided the wireless communication scenario, wherein the intermediate component comprises a reconfigurable signal emitter, wherein for the beam alignment process, the reconfigurable signal emitter is controlled with regard to a first member that detects the identifier associated with the reconfigurable signal emitter and, sequentially or in parallel with regard to a second member that detects the identifier associated with the reconfigurable signal emitter to align beams of the first member and the second member to an indirect communication, e.g., a non-line-of-sight path.

According to an embodiment there is provided the wireless communication scenario, comprising, in a same path or in different paths to the member, at least two intermediate components each comprising a reconfigurable signal emitter, the wireless communication scenario adapted for commonly controlling the reconfigurable signal emitters.

According to an embodiment there is provided the wireless communication scenario, wherein the intermediate component is adapted to create a path component in the radio propagation environment.

According to an embodiment there is provided the wireless communication scenario, wherein the intermediate component comprises at least one of:
a reconfigurable intelligent surface, RIS;
a repeater;
an integrated access and backhaul, IAB, device;
a sidelink relay;
a user equipment, UE

According to an embodiment there is provided the wireless communication scenario, wherein the member and is a first member and wherein the wireless communication scenario comprises a second member communicating via the path component,
wherein the first member and the second member are configured for directly or indirectly exchanging information relating to an object or beacon in the wireless communication scenario being detectable for the first member and/or for the second member and for identifying the path component based on the object, e.g., associating the path component with a location of the object.

According to an embodiment there is provided the wireless communication scenario, comprising a database, e.g., an almanac having stored therein a set of identifiers and an associated set of beacon information, wherein the beacon information comprises information associated with a beacon providing the identifier;
wherein the member of the wireless communication scenario is configured for detecting the identifier and for identifying the path component based on the identifier and based on the database.

According to an embodiment there is provided the wireless communication scenario, wherein the beacon information comprises at least one of:
a position of the beacon;
an angle of arrival of an incoming wireless signal at the beacon;
an angle of departure of an outgoing wireless signal at the beacon;
an angle between an angle of arrival of the incoming wireless signal and an angle of departure of the outgoing wireless signal;
a stability of the path component;
a reliability of the path component
at least one signal property measurable with the path component received by the beacon; e.g. phase, delay relationship to other reference signals (time anchor, phase anchor, amplitude anchor).

According to an embodiment there is provided the wireless communication scenario, wherein the member of the wireless communication scenario is configured for detecting an identifier; and for detecting a presence of the path component and for determining an identity of the path component of the wireless communication scenario by use of the identifier.

According to an embodiment there is provided the wireless communication scenario, wherein the member is configured for receiving the wireless signal and the identifier and for providing the identifier to a database that has stored therein associated beacon information and for receiving at least a part of the beacon information to identify the path component.

According to an embodiment there is provided the wireless communication scenario, wherein the member is configured for selecting or deselecting at least one available path component for transmission or reception of a wireless signal based on the identity of a path component.

According to an embodiment there is provided the wireless communication scenario, being configured for providing, to the member beacon information associated with the identifier, the beacon information related to an availability of the path component;
wherein the member is configured for selecting or deselecting the at least one available path component based on the beacon information.

According to an embodiment there is provided the wireless communication scenario, wherein the member is configured to select or deselect the at least one available path component for a transmission of a signal based on an interference information indicating an interference, e.g., cross-link-interference, to mitigate interference when compared to a use of a different identifiable path component.

According to an embodiment there is provided the wireless communication scenario, wherein the member is configured to select an the at least one path component for a transmission of a signal based on a stability information being part of the beacon information and indicating a reliability of the identifiable path component.

According to an embodiment there is provided the wireless communication scenario, wherein the member is configured for distinguishing between a direct communication, e.g., a line-of-sight-path, and an indirect communication, e.g., a non-line-of-sight path, within the wireless communication scenario based on a beacon associated with the path component, the beacon associated with the beacon information.

According to an embodiment there is provided the wireless communication scenario, being adapted for receiving information relating to different or to a same path component from a set of entities and for combining the received information to obtain combined information and for providing the combined information as at least a part of a beacon information indicating a presence of the beacon in the wireless communication scenario.

According to an embodiment there is provided the wireless communication scenario, wherein the member is configured for favouring or not favouring/avoiding tagged path components over non-tagged path components for communication. That is, the member may prioritize or de-prioritize the tagged path component over non-tagged component.

According to an embodiment there is provided the wireless communication scenario, wherein the member is configured for communicating in the wireless communication scenario with a communication partner; and wherein the member is configured for identifying the path component and for obtaining beacon information associated with the path component, beacon information indicating an origin and/or a destination of the path component;
wherein the member is configured for selecting or deselecting the path component based on the origin and/or destination by planning an obstructed line-of-sight, OLOS, propagation of a signal to be transmitted to the communication partner and/or an OLOS reception of a signal to be received from the communication partner.

According to an embodiment there is provided the wireless communication scenario, wherein the beacon information relates to an availability of a set of spatial communication paths through the wireless communication system; wherein to each identified path component at least one spatial path is associated; wherein the member is configured selecting or deselecting the path component based on a route between the device and the communication partner.

According to an embodiment there is provided the wireless communication scenario, wherein the beacon information relates to a spatial availability of the path component or a beacon associated with the path component, e.g., a 2D information and/or a 3D-information.

According to an embodiment there is provided the wireless communication scenario, wherein the beacon information relates to a reliability information or a temporal availability of the identifiable path component or a beacon associated with the identifiable path component.

According to an embodiment there is provided the wireless communication scenario, wherein the member of the wireless communication scenario is configured for:
identifying a set of path components available for the member;
obtaining, for each of the identified path component, associated beacon information that relates to a spatial availability of the path component; and
determining a location of the device based on the set of path components and the beacon information.

According to an embodiment there is provided the wireless communication scenario, comprising a database, e.g., an almanac, having stored therein a set of identifiers and an associated set of beacon information; wherein the beacon information indicates at least one of:
a location of a beacon providing the identifier, and
an identity of the beacon;
an identity of the object to which the beacon is associated;
a spatial property of the identifiable path component;
one or more coverage directions;
one or more beam directions;
beam coverage angular range;
a type of the beacon such as stationary, transportable or mobile;
if mobile, 2D or 3D moving device;
if mobile, trajectory information;
a modification implemented by the beacon.

According to an embodiment there is provided the wireless communication scenario, wherein the member is configured for deriving, from the beacon information, information about the object to which the beacon is fitted or mounted or that comprises the beacon.

According to an embodiment there is provided the wireless communication scenario, wherein the path component is at least a part of a direct communication, e.g., a line of sight component, or an indirect communication, e.g., a non-line-of sight component.

According to an embodiment there is provided the wireless communication scenario, wherein the member is configured for identifying a plurality of path components available during an instance of time.

According to an embodiment there is provided the wireless communication scenario, wherein the member is a UE or a base station.

According to an embodiment there is provided a device configured for operating as the member in the wireless communication scenario according to one of previous aspects.

According to an embodiment there is provided a beacon configured for operating in a wireless communication scenario, the beacon comprising:
a wireless interface;
wherein the beacon is configured for receiving an incoming wireless signal with the wireless interface and for modifying the incoming wireless signal with a modification to obtain a modified wireless signal; and for transmitting the modified wireless signal as an outgoing signal with the wireless interface;
wherein the modification is associated with the beacon in the wireless communication scenario to associate a path component of the wireless communication scenario with the beacon.

According to an embodiment there is provided a method for operating a wireless communication scenario, comprising:
providing a propagation of a signal via a path component of a radio propagation environment;
wirelessly communicating in the wireless communication scenario with a plurality of devices;
such that a member of the wireless communication scenario identifies the path component of a signal travelling through the radio propagation environment.

According to an embodiment there is provided a method for establishing an indirect, e.g., non-line-of-sight, communication between a first member and a second member via an intermediate component, the method comprising:
controlling the intermediate component so as to comprise different properties, each property influencing a relationship between an incoming signal and an outgoing signal, the outgoing signal being obtained responsive to the incoming signal;
selecting a property from the different properties such that the incoming signal being transmitted by the first member leads to the outgoing signal being received by the second member or vice versa.

According to an embodiment, there is provided the method above, comprising, after the indirect communication is established, at least one of optimizing:
a beam of the first member, e.g., with respect to an orientation towards the intermediate component;
a beam of the second member, e.g., with respect to an orientation towards the intermediate component; and
the property of the intermediate component
   based on the selected property.

According to an embodiment there is provided the method above, being performed in a wireless communication scenario of aspects or embodiments described herein.

According to an embodiment there is provided the method above, wherein controlling the intermediate component so as to comprise the different properties comprises a first controlling during which the intermediate component is controlled into first properties based on requirements of the first member; and comprises a second controlling during which the intermediate component is controlled into second properties based on requirements of the second member; wherein the first controlling is timely disjoint with the second controlling or at least partly overlaps in time; wherein the selected property is a property that matches the requirements of the first member and of the second member.

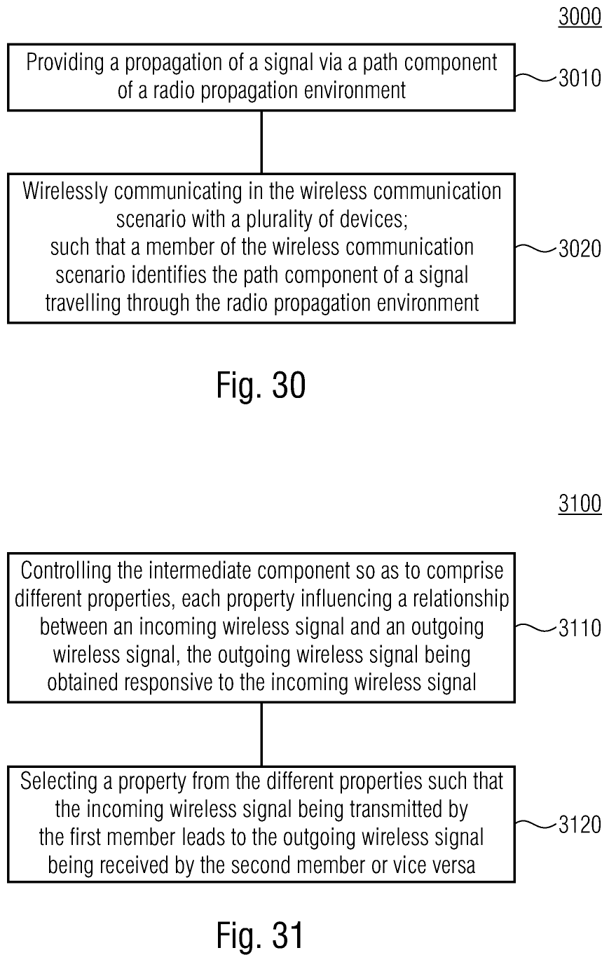

FIG. 30 shows a schematic block diagram of a method 3000 according to an embodiment that may be used for operating wireless communication scenario. A step 3010 comprises providing a propagation of a signal via a path component of a radio propagation environment. A step 3020 comprises wirelessly communicating in the wireless communication scenario with a plurality of devices. Method 3000 is implemented such that a member of the wireless communication scenario identifies the path component of a signal travelling through the radio propagation environment.

FIG. 31 shows a schematic flow chart of a method 3100 according to an embodiment that may be used for establishing an indirect, e.g., non-line-of-sight wireless communication between a first member and a second member via an intermediate component. A step 3110 comprises controlling the intermediate component so as to comprise different properties, each property influencing a relationship between an incoming wireless signal and an outgoing wireless signal, the outgoing wireless signal being obtained responsive to the incoming wireless signal. A step 3120 comprises selecting a property from the different properties such that the incoming wireless signal being transmitted by the first member leads to the outgoing wireless signal being received by the second member or vice versa. For example, this may relate to a reconfigurable signal emitter.

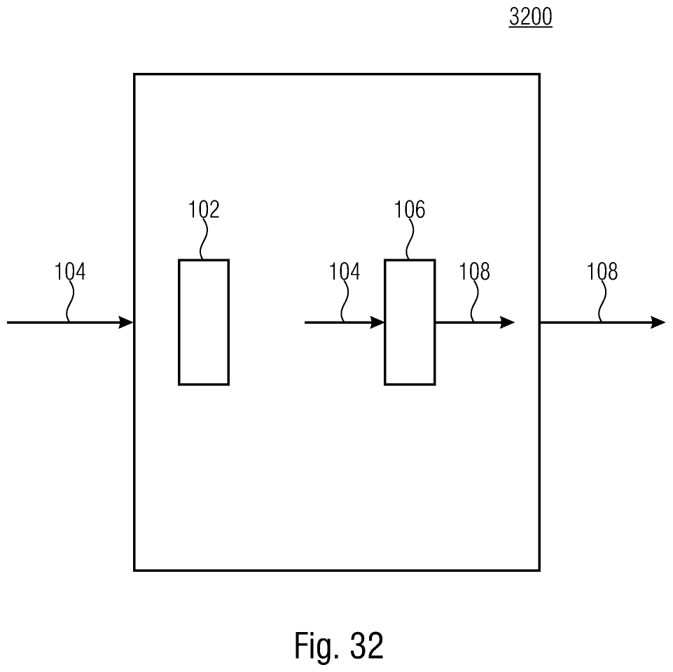

FIG. 32 shows a schematic block diagram of a beacon 3200 according to an embodiment, that may be used, for example, as beacon 34 and/or as beacon 42. Beacon 3200 comprises a wireless interface 102 configured for receiving and transmitting wireless signals. The beacon 3200 is configured for receiving an incoming wireless signal 104 with the wireless interface 102 and for modifying the incoming wireless signal with a modification 106 to obtain a modified wireless signal 108 and for transmitting the modified wireless signal as an outgoing wireless signal 108 with the wireless interface 102. The modification 106 is associated with the beam in the wireless communication scenario in which the beacon is operated to associate a path component of the wireless communication scenario with the beacon. As described, such a modification may relate to inserting information into the modified wireless signal 108, modifying it in a static or variable, controllable manner, e.g., in view of a direction of the incoming/outgoing signal, an orientation of a surface reflective for the incoming signal, a transparency/reflectivity of a surface reflective for the incoming signal, a refractive index of a surface refractive for the incoming signal, a polarization of the outgoing signal, a frequency range processed for incoming signals and/or for outgoing signals, an attenuation of the outgoing signal, a gain applied to the outgoing signal, a gain applied to the outgoing signal, a phase change applied to the outgoing signal with respect to the incoming signal, a selection of at least one array element of an antenna array of the intermediate component, a shape or curvature of the reflective surface for reflecting the incoming signal or the like.

According to an embodiment, a beacon or beacon device may be configured for operating or being recognised in at least two directions, e.g., from one device to another and along the opposing direction or in uplink and downlink. The beacon may operate similar or differently along such different directions, wherein also more than two directions are possible.

According to an embodiment, a device, e.g., a member described herein, is configured to operate in a wireless communication scenario that comprises a radio propagation environment, the device is configured for identifying a path component of a wireless signal travelling through the radio propagation environment.

According to an embodiment, the device is configured for operating as the member in the wireless communication scenario described herein.

According to an embodiment device, e.g., a base station is configured for operating in a wireless communication scenario, the device configured for selectively tagging a signal transmitted by the device when directing the signal along a predetermined path in the wireless communication scenario and with a tag that is associated with the path.

According to an embodiment, the device, e.g., base station, is configured for not using the tag or for not tagging the signal transmitted along a different path.

According to an embodiment there is provided a computer readable digital storage medium having stored thereon a computer program having a program code for performing, when running on a computer, a method described herein.

Embodiments provide for a set of advantages. Amongst those, there are
The use of beacons can assist choosing appropriate beam directions at the base station and/or the device when using MIMO. Furthermore, extend from single stream to multi-stream (MIMO).
Assuming CSI feedback is provided in a MPC specific manner for example, delay specific or direction specific (currently its chosen on a wideband basis or with respect to sub bands), then appearance, duration (time of availability) decay/disappearance can be supported in MPC monitoring and prediction.
Additional side information from a HD map (where Beacons are listed—almanac) can allow predictive directional beamforming.
Beacon could be self-explaining with respect to location (geo-location) or describing the surface and its properties.
Furthermore, a beacon allows to track a particular and prominent/dominant reflector more easily.
Marking of a reflector by a beacon allows to distinguish between a LOS and a reflection (NLOS).
Furthermore, each device could advertise and share all surfaces detected via beacons as available/accessible reflectors/first bound scatterers with the current beam radiation pattern in Tx or Rx mode.
The identified dominant and beacon-identifiable MPCs can be reported to the
communication partner for example, base station with reference to the applied/observed SSB, CSI-RS, SRS beams used in DL and/or UL.
The feedback could be extended to include interferers causing ICI and/or CLI
If 2 nodes communicating with each other will see the same reflector (beacon-identifiable MPC) then this MPC could be used as a single bounce scatterer connecting the communicating devices in a single bounce NLOS fashion. Both devices could easily track the beacon as assisting signal for dominant path tracking. Furthermore, the received beacon could be compared with the signal from the communication partner in order to derive stability, power evolution and/or beam pairing quality above a threshold or during an beam management/optimization process.
Knowledge about stable reflectors/MPCs provides benefits for timing advance (TA) and/or time reversal schemes

Beacon-identifiable reflectors/MPCs can be used in a similar fashion as BLE beacons are used today. This allows for two very different implementations:
Beacons are at fixed locations/positions and distributed is space and the receiver knows about their locations and therefore can obtain/derive information about its own location. This can be implemented in different ways: for example, by using active beacons at known positions (with synced or non-synced beacons) and/or by detecting radio signals coming from a source via distinguishable reflections (MPCs) which are clearly marked by beacons. With further knowledge of the position of the transmitting sources and the position of the beacon-identifiable MPCs the location of the receiver can be estimated using multi-path ranging with even a single anchor.
Beacons are attached to mobile devices and will be tracked by for example, receivers with known positions for example, infrastructure receivers at base stations. As described in the example above the same method can be applied when estimating the position of devices/UEs exploiting the propagation via beacon-identifiable MPCs and knowledge about the position of the receiver (base station) and the beacon-identifiable reflectors (MPCs).

The similarity between localization and communication is that in localization the mobile beacon is equivalent to a UE operating in UL whereas a fixed beacon is equivalent to a BS operating in DL.

### Applications Fields.

Further beacon applications include communication and positioning involving one or more non-terrestrial devices:
Active MPCs (relays), wherein the I/O relationship is configurable (using active antenna arrays). Here configurable also means controlling the angles of incidence and reflection. Active MPCs may be strategically placed on geolocations with desirable LOS conditions for many users. For example, on top of mountain ridges, very-low earth orbiting satellite (VLEO) platforms. Assuming a VLEO constellation to be used by several basestations to serve their users via the active reflectors, the beacon identifier on each satellite relay will allow interference mitigation by selecting an appropriate subset of satellites for each user link according to the desired/proposed/needed multipath selection scheme.
Consider a sidelink connection that relies on knowledge of particular MPCs which can be used during a certain window of opportunity—e.g. two UEs on either side of a mountain range using VLEOs to communicate via the sidelink. Beacons on the VLEOs allow identification of directions/angles (arrival/departure) suitable for successful links. Observation of beacons allows devices to predict the opening of the window of opportunity.
Additional information regarding the capability and availability of VLEOs is derived from the almanac.
Further examples include UAVs (including drones and swarms of drones), manned aircraft, high-altitude platforms (HAPs) and other earth orbiting satellites, e.g. MEO, HEI, GSO, NGSO etc.
Airborne platforms (UEs) make use of terrestrial beacons to identify TRPs. Beacons are used on top of the PBCH wherein the beacons have a larger range than the PBCH itself. This is used to initiate link alignment—e.g. via initial access—and the gNB is responding with a link directed to the UE (aeroplane).
An airborne device flying in a valley or (building tops) recognizes IMPCs allowing it to create radio maps with MPC accuracy. This is effectively a dimensional extension of the 2D use case involving ground-based vehicles (2D/3D).

Embodiments described herein relate to devices that are capable of communicating in a wireless communication scenario. Such a device may comprise an antenna or an antenna arrangement or at least one antenna panel and is possibly able to implement a beamforming. The device may comprise at least one reception chain and/or at least one transmission chain for processing, generating and/or receiving wireless signals. Such a device may comprise a memory and/or a processor or control unit configured for communication and/or signal processing.

According to an embodiment, a beaconing mechanism or a beacon may be implemented as a part of a transmitter, e.g., when having knowledge at the receiver that a specific property or parameter or content of at least a part of the received signal is associated with a specific path component. That is, not only an intermediate device may use a beaconing mechanism but, alternatively or in addition also a transmitter or signal source.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| Abbrevia- | | Further |
|---|---|---|
| tion | Definition | description |
| 2G | second generation | |
| 3G | third generation | |
| 3GPP | third generation partnership project | |
| 4G | fourth generation | |
| 5G | fifth generation | |
| 5GC | 5G core network | |
| ACLR | adjacent channel leakage ratio | |
| AGC | automatic gain control | |
| AP | access point | |
| ARQ | automatic repeat request | |
| BER | bit-error rate | |
| BLER | block-error rate | |
| BH | backhaul | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP1 | control plane 1 | |
| CP2 | control plane 2 | |
| CSI-RS | channel state information reference | |
| CU | central unit | |
| D2D | device-to-device | |
| DAPS | dual active protocol stack | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DU | distributed unit | |
| ECGI | E-UTRAN cell global identifier | |
| E-CID | enhanced cell ID | |
| eNB | evolved node b | |
| EN-DC | E-UTRAN-New Radio dual connectivity | |
| EUTRA | Enhanced UTRA | |
| E-UTRAN | Enhanced UTRA network | |
| gNB | next generation node-b | |
| GNSS | global navigation satellite system | |
| GPS | global positioning system | |
| HARQ | hybrid ARQ | |
| IAB | integrated access and backhaul | |
| ID | identity/identification | |
| IIOT | industrial Internet of things | |
| IM | interference management | |
| KPI | key-performance indicator | |
| LTE | Long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MT | mobile termination | |
| MR-DC | multi-RAT dual connectivity | |
| NCGI | new radio cell global identifier | |
| NG | next generation | |
| ng-eNB | next generation eNB | node providing |
| | | E-UTRA |
| NG-RAN | either a gNB or an ng-eNB | |
| NR | new radio | |
| NR-U | NR unlicensed | NR operating in |
| | | unlicensed |
| OAM | operation and maintenance | |
| OEM | OEM original equipment manufacturer | |
| OTT | OTT over-the-top | |
| PCI | physical cell identifier | Also known as |
| | | PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RF | radio frequency | |
| RIM | radio access network information | |
| RIM-RS | RIM reference signal | |
| RIS | reconfigurable intelligent surface | |
| RLC | radio link control | |
| RLF | radio link failure | |
| RLM | radio link monitoring | |
| RP | reception point | |
| R-PLMN | registered public land mobile network | |
| RRC | radio resource control | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| SA | standalone | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TDD | time division duplex | |
| TSG | technical specification group | |
| UE | user equipment | |
| UL | uplink | |
| URLLC | ultra-reliable low latency communication | |
| UTRAN | universal trunked radio access network | |
| V2X | vehicle-to-everything | |
| VoIP | voice over Internet protocol | |
| WI | work item | |
| WLAN | wireless local area network | |

1. A wireless communication scenario comprising a radio propagation environment providing for a propagation of a wireless signal via a path component, the wireless communication scenario comprising:
a plurality of devices configured for wirelessly communicating in the wireless communication scenario;
wherein a member of the wireless communication scenario is configured for identifying the path component of the wireless signal travelling through the radio propagation environment;
wherein the member is configured for receiving the wireless signal and an identifier and for deriving, based on the identifier, that the wireless signal was received via the path component for identifying the path component.

2. The wireless communication scenario of claim 1, wherein the wireless communication scenario is adapted for a propagation of the wireless signal via a single path component or via a multiple path components within a multipath propagation environment.

3. The wireless communication scenario of claim 1, wherein the member is configured for identifying a plurality of path components available for the member for wireless communication and for selecting a subset from the plurality of path components for the wireless communication based on a criterion whilst not selecting at least one available path component from the plurality of path components and for using the selected subset for the wireless communication.

4. The wireless communication scenario of claim 3, wherein the member is configured for selecting or combining the subset based on a parameter describing the path component being at least one of:
received power level, such as RSRP or RSSI or RSRQ
delay, delay difference or delay spread
stability,
long term availability
easy to track
traceability
separability
blockage probabilities,
accessibility with beamforming capabilities.

5. The wireless communication scenario of claim 1, wherein the member is configured for identifying a plurality of path components available for the member for wireless communication and for selecting a subset from the plurality of path components for the wireless communication based on a criterion whilst not selecting at least one available path component from the plurality of path components and for reporting the selected subset to another member of the wireless communication scenario as:
advantageous or not advantageous for the wireless communication; or
being used in the wireless communication with another member.

6. The wireless communication scenario of claim 3, wherein the member is configured for selecting the subset as a first subset and for selecting a second subset of path components prior to or during using the first subset; and for switching from the first subset to the second subset based on a predetermined event or signal.

7. The wireless communication scenario of claim 3, wherein the member is configured for selecting the subset as a first subset and for selecting a second subset of path components prior to or during using the first subset; wherein the member is configured for selecting the second subset as an auxiliary subset and for using the second subset instead of the first subset in case of a link degradation or link failure.

8. The wireless communication scenario of claim 3, wherein the member is configured for selecting the subset as a first subset and for selecting a second subset of path components prior to or during using the first subset; wherein the member is configured select between the first subset and the second subset based on a condition and/or based on a direct control.

9. The wireless communication scenario of claim 3, wherein the member is configured for using a first subset prior to using a second subset of path components; and for switching from the first subset to the second subset based on a predetermined event or signal; or
selecting to use of the first subset or the second subset based on predefined criteria or event.

10. The wireless communication scenario of claim 1, wherein the wireless communication scenario is configured for:
tagging the path component with an identifier associated with the path component;
identifying the path component based on the identifier.

11. The wireless communication scenario of claim 1, wherein the wireless communication scenario is configured for instructing at least one beacon to insert a beacon-specific information into a predetermined resource, e.g., a time and/or frequency resource of, e.g., a CORESET, a DCI, MIB or SIB, wherein the beacon is configured to operate accordingly.

12. The wireless communication scenario of claim 1, wherein the wireless communication scenario is configured for performing a beam alignment process by use of at least three distributed components for jointly forming an indirect communication, e.g., using a non-line-of-sight path, of the wireless communication scenario.

13. The wireless communication scenario of claim 12, wherein the at least three components comprise a first member, a second member and an intermediate component associated with the beacon to provide the path component.

14. The wireless communication scenario of claim 12, wherein the indirect communication comprises a reconfigurable signal emitter as an intermediate component, the reconfigurable signal emitter configured for emitting an outgoing signal based on the incoming wireless signal;
wherein the wireless communication scenario is configured for changing a property of the reconfigurable signal emitter in accordance with a received control signal.

15. The wireless communication scenario of claim 14, wherein the wireless communication scenario is adapted for forming a plurality of beams comprising different beam directions for at least one position of the reconfigurable signal emitter to acquire a corresponding plurality of results, if the identifier is visible or not at the position of the reconfigurable signal emitter.

16. The wireless communication scenario of claim 14, wherein the reconfigurable signal emitter is one of an active signal forwarder and a passive signal forwarder.

17. The wireless communication scenario of claim 14, wherein the property of the reconfigurable signal emitter relates to at least one of:
a direction of the incoming signal
a direction of the outgoing signal
an orientation of a surface reflective for the incoming signal;
a transparency/reflectivity of a surface reflective for the incoming signal;
a refractive index of a surface refractive for the incoming signal;
a polarisation of the outgoing signal;
a frequency range processed for incoming signals or of outgoing signals
an attenuation of the outgoing signal;
a gain applied to the outgoing signal;
a phase change applied to the outgoing signal with respect to the incoming signal;
a selection of at last one array element of an antenna array of the intermediate component;
a shape or curvature of a reflective surface for reflecting the incoming signal

18. The wireless communication scenario of claim 1, wherein the member is a first member and wherein the wireless communication scenario comprises a second member communicating via the path component,
wherein the first member and the second member are configured for directly or indirectly exchanging information relating to an object or beacon in the wireless communication scenario being detectable for the first member and/or for the second member and for identifying the path component based on the object, e.g., associating the path component with a location of the object.

19. The wireless communication scenario of claim 1, wherein the member of the wireless communication scenario is configured for detecting an identifier; and for detecting a presence of the path component and for determining an identity of the path component of the wireless communication scenario by use of the identifier.

20. The wireless communication scenario of claim 1, wherein the member of the wireless communication scenario is configured for:
identifying a set of path components available for the member;
acquiring, for each of the identified path component, associated beacon information that relates to a spatial availability of the path component; and
determining a location of the device based on the set of path components and the beacon information.

21. The wireless communication scenario of claim 1, comprising a database having stored therein a set of identifiers and an associated set of beacon information; wherein the beacon information indicates at least one of:
a location of a beacon providing the identifier, and
an identity of the beacon;
an identity of the object to which the beacon is associated;
a spatial property of the identifiable path component;
one or more coverage directions;
one or more beam directions;
beam coverage angular range;
a type of the beacon such as stationary, transportable or mobile;
if mobile, 2D or 3D moving device;
if mobile, trajectory information;
a modification implemented by the beacon.

22. A device configured to operate in a wireless communication scenario comprising a radio propagation environment, the device configured for identifying a path component of a wireless signal travelling through the radio propagation environment;
wherein the device is configured for receiving the wireless signal and an identifier and for deriving, based on the identifier, that the wireless signal was received via the path component for identifying the path component.

23. A device, e.g., a base station configured for operating in a wireless communication scenario, the device configured for selectively tagging a signal transmitted by the device when directing the signal along a predetermined path in the wireless communication scenario and with a tag that is associated with the path; so that the tag identifies the path.
